(19) United States
(12) Patent Application Publication
(10) Pub. No.: US 2021/0390535 A1
(43) Pub. Date: Dec. 16, 2021

(54) PAYMENT SERVICE APPARATUS, PAYMENT SERVICE SYSTEM, PAYMENT SERVICE METHOD, AND PAYMENT SERVICE PROGRAM

(71) Applicant: TOYOTA JIDOSHA KABUSHIKI KAISHA, Toyota-shi (JP)

(72) Inventor: Shoji ITOH, Nagoya-shi (JP)

(73) Assignee: TOYOTA JIDOSHA KABUSHIKI KAISHA, Toyota-shi (JP)

(21) Appl. No.: 17/324,630

(22) Filed: May 19, 2021

(30) Foreign Application Priority Data
Jun. 16, 2020 (JP) 2020-103868

(51) Int. Cl. G06Q 20/38; G06Q 20/40; G06Q 20/32; G06Q 30/06

(52) U.S. Cl. CPC G06Q 20/3821; G06Q 30/0645; G06Q 20/3278; G06Q 20/40145

(57) ABSTRACT

A payment service server includes functions of a payment function unit, an authentication function unit, and an authentication and payment processing unit. The authentication and payment processing unit executes a process of receiving a payment request containing user information from a client terminal equipped with a payment function and used by a first user, authenticating a user by using the authentication function unit, and, when a second user different from the first user is authenticated, performing a payment process by using the payment function unit for the second user.

### CROSS-REFERENCE TO RELATED APPLICATION

This application claims priority to Japanese Patent Application No. 2020-103868 filed on Jun. 16, 2020, incorporated herein by reference in its entirety.

### BACKGROUND

### 1. Technical Field

The present disclosure relates to a payment service apparatus, a payment service system, a payment service method, and a payment service program that enable a person to make a payment.

### 2. Description of Related Art

Japanese Unexamined Patent Application Publication No. 2015-176469 (JP 2015-176469 A) suggests a payment method that enables a smartphone to have the function of a plastic or paper-type membership card and to use the function. More specifically, the payment method of JP 2015-176469 A includes a step of displaying a function selection screen containing a button for selecting a points accumulate and use function as a smartphone of a seller is activated, a step of recognizing an optical code displayed on a smartphone of a purchaser as the points accumulate and use function is selected, a step of displaying a screen for showing accumulated points, corresponding to the recognized optical code, and inputting points used and a payment amount as the optical code is recognized, a step of, as an apply button is selected after the seller inputs the payment amount, transmitting a payment amount recalculated in accordance with the points used to a mobile wallet management system so that the recalculated payment amount is provided to an electronic payment service PG system.

### SUMMARY

However, people who have no client terminals that are mobile terminals and other terminals, such as smartphones and tablet terminals, capable of providing payment services are not able to use payment services, so there is room for improvement.

The present disclosure provides a payment service apparatus, a payment service system, a payment service method, and a payment service program that enable a person who has no client terminal capable of providing a payment service, to use a payment service.

A first aspect of the present disclosure provides a payment service apparatus. The payment service apparatus includes: a reception unit configured to receive user information from a client terminal equipped with a payment function and used by a first user; and a processing unit configured to, when a user authenticated based on the user information received by the reception unit is a second user different from the first user, perform a payment process for the second user.

With the payment service apparatus according to the above aspect, the reception unit is configured to receive user information from a client terminal equipped with a payment function and used by a first user.

The processing unit is configured to, when a user authenticated based on the user information received by the reception unit is a second user different from the first user, perform a payment process for the second user. With this configuration, even when the second user has no client terminal capable of providing a payment service, the second user is enabled to perform a payment process by using the client terminal of the first user. Therefore, a person who has no client terminal capable of providing a payment service is enabled to use a payment service.

The reception unit may be configured to, when the reception unit receives the user information, further receive position information of the client terminal. With this configuration, it is possible to acquire the position of a user as a history at the time of payment and use the history as information to track fraud.

The client terminal may be configured to, after the processing unit performs the payment process, delete historical information about the second user. With this configuration, it is possible to protect private information.

The processing unit may be configured to, when the authenticated user is the second user, further return a predetermined bonus to the first user. It is possible to provide the first user with a value resulting from lending the client terminal and allowing the second user to make a payment with the client terminal.

The client terminal may include a photographing unit. The reception unit may be configured to receive a photograph of biometric information or predetermined authentication print of a user, taken by the photographing unit, as the user information. With this configuration, since user information is input just by taking a photograph, it is possible to easily perform input operation as compared to text input.

The payment service apparatus may further include a preprocessing unit configured to, after the user is authenticated and registered, execute a process of generating an authentication code for printing out the authentication print and prompting to print out the generated authentication code. With this configuration, a user carrying authentication print is enabled to use a payment service by using a client terminal of another person.

A second aspect of the present disclosure provides a payment service system. The payment service system includes: the payment service apparatus according to the first aspect; a service providing apparatus configured to provide a predetermined service; and a client terminal equipped with a payment function and used by the first user and used to input the user information of a user to which the service is provided.

With the payment service system according to the above aspect, a predetermined service is provided by the service providing apparatus.

In addition, when the user information of a user to which a service is provided is input with the client terminal equipped with a payment function and used by the first user, the user is enabled to use a predetermined service provided by the service providing apparatus. With the payment service apparatus, a person who has no client terminal capable of providing a payment service is enabled to use a payment service for a predetermined service.

The service providing apparatus may be configured to provide a vehicle allocation service on allocation of a vehicle. The client terminal may include a photographing unit. The payment service apparatus may be configured to, when allocation of a vehicle is arranged by using the vehicle allocation service, identify the second user by using a photo image obtained by taking a photograph of authentication print printed in advance and held by the second user.

A third aspect of the present disclosure provides a payment service method to be executed by a computer. The payment service method includes: receiving user information from a client terminal equipped with a payment function and used by a first user; executing a process of authenticating a user based on the received user information; and, when the authenticated user is a second user different from the first user, performing a payment process for the second user.

With the payment service method according to the above aspect, user authentication is performed by receiving user information from the client terminal equipped with a payment function and used by the first user and executing a process of authenticating a user based on the received user information. When the authenticated user is a second user different from the first user, a payment process is performed for the second user. With this configuration, even when the second user has no client terminal capable of providing a payment service, the second user is enabled to perform a payment process by using the client terminal of the first user. Therefore, a person who has no client terminal capable of providing a payment service is enabled to use a payment service.

A fourth aspect of the present disclosure provides a payment service program for causing a computer to function as the units of the payment service apparatus according to the first aspect.

As described above, according to the aspects of the present disclosure, it is advantageously possible to provide a payment service apparatus, a payment service system, a payment service method, and a payment service program that enable a person who has no client terminal capable of providing a payment service, to use a payment service.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing the schematic configuration of an information processing system according to a first embodiment;

FIG. 2 is a block diagram showing the configuration of a main part of an electrical system of each of a payment service server, a vehicle allocation scheduling server, an operation management server, a client terminal, and a vehicle-side terminal;

FIG. 3 is a functional block diagram showing the functional configuration of the payment service server according to the embodiment;

FIG. 4 is a functional block diagram showing the functional configuration of the vehicle allocation scheduling server according to the embodiment;

FIG. 5 is a view showing A to E regions for illustrating an example of an operation area;

FIG. 6 is a flowchart showing an example of a process to be executed by the vehicle allocation scheduling server of the information processing system according to the embodiment;

FIG. 7 is a view for illustrating a precondition for an example of a vehicle allocation schedule;

FIG. 8 is a view for illustrating a reference schedule plan for a vehicle allocation candidate;

FIG. 9 is a view for illustrating a first plan for a vehicle allocation candidate;

FIG. 10 is a view for illustrating a second plan for a vehicle allocation candidate;

FIG. 11 is a view for illustrating a third plan for a vehicle allocation candidate;

FIG. 12 is a view for illustrating a fourth plan for a vehicle allocation candidate;

FIG. 13A, FIG. 13B, FIG. 13C, FIG. 13D and FIG. 13E are tables showing results obtained by calculating the details of dispatch candidates in the reference schedule plan and first to fourth plans for a vehicle allocation candidate;

FIG. 14 is a flowchart showing an example of a process to be executed by the client terminal for user registration in order to use a service provided by the payment service server of the information processing system according to the first embodiment;

FIG. 15 is a flowchart showing an example of a process to be executed for user registration on the payment service server when the process is executed by the client terminal for user registration in the information processing system according to the first embodiment;

FIG. 16 is a sequence diagram showing a process to be executed for user registration when the service provided by the payment service server of the information processing system according to the embodiment shown in FIG. 1 is used;

FIG. 17 is a flowchart showing an example of a process to be executed by the client terminal to make a vehicle booking and make a payment in the information processing system according to the first embodiment;

FIG. 18 is a flowchart showing an example of a process to be executed by the vehicle allocation scheduling server to make a vehicle booking and make a payment in the information processing system according to the first embodiment;

FIG. 19 is a flowchart showing an example of a process to be executed by the payment service server to make a vehicle booking and make a payment in the information processing system according to the first embodiment;

FIG. 20 is a sequence diagram showing a process to be executed to make a vehicle booking and make a payment in the information processing system according to the first embodiment;

FIG. 21 is a flowchart showing an example of a process to be executed by a vehicle-side terminal at the time of getting on or off a booked vehicle in the information processing system according to the first embodiment;

FIG. 22 is a flowchart showing an example of a process to be executed by the payment service server at the time of getting on or off a booked vehicle in the information processing system according to the first embodiment;

FIG. 23 is a flowchart showing an example of a process to be executed by the vehicle allocation scheduling server at the time of getting on or off a booked vehicle in the information processing system according to the first embodiment;

FIG. 24 is a sequence diagram showing a process to be executed at the time of getting on or off a booked vehicle in the information processing system according to the first embodiment;

FIG. 25 is a diagram showing the schematic configuration of an information processing system according to a second embodiment;

FIG. 26 is a block diagram showing the configuration of a main part of an electrical system of each of a shopping support server, a product management server, a distribution management server, and a shopping service operator terminal;

FIG. 27 is a view showing a default screen, a shopping item select screen, and a shop select screen as examples of screens to be displayed by a support application preinstalled in the client terminal;

FIG. 28 is a view showing a shopping support select screen, a streaming screen, a shopping list on/off select screen, and a shopping list screen as examples of screens to be displayed for shopping at shops; and

FIG. 29 is a view showing a payment screen, a delivery screen, a payment service authentication screen, and an authentication confirmation screen as examples of screens to be displayed when “PROCEED TO CHECKOUT” is selected on the streaming screen or the shopping list screen.

### DETAILED DESCRIPTION OF EMBODIMENTS

Hereinafter, example embodiments of the present disclosure will be described with reference to the accompanying drawings.

### First Embodiment

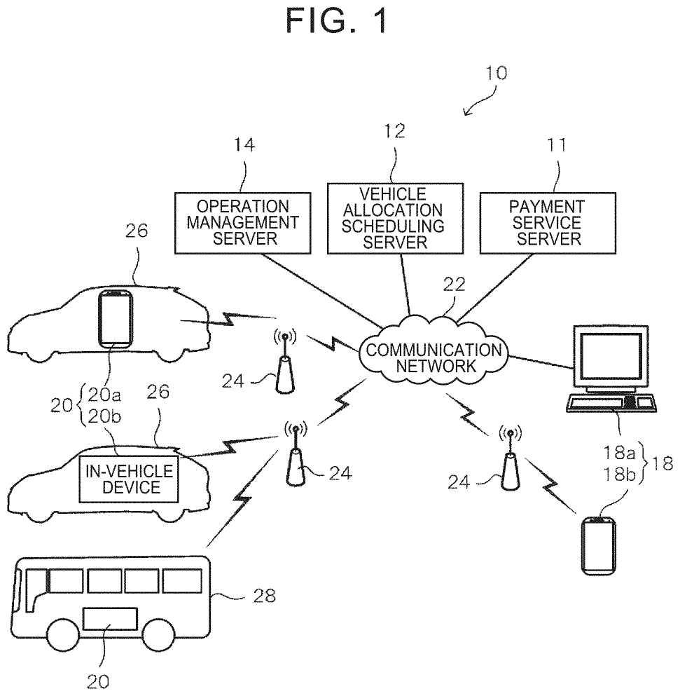

FIG. 1 is a diagram showing the schematic configuration of an information processing system according to a first embodiment. The present embodiment will be described on the assumption that an information processing system 10 including a plurality of servers is an example of a payment service system.

As shown in FIG. 1, the information processing system 10 according to the present embodiment includes a payment service server 11 as a payment service apparatus, a vehicle allocation scheduling server 12 as a service providing apparatus, an operation management server 14, client terminals 18, and vehicle-side terminals 20. The servers and terminals are connected to a communication network 22.

The payment service server 11 receives user information from a client terminal equipped with a payment function and used by a first user and, when a user authenticated based on the user information is a second user different from the first user, performs a payment process for the second user. With this configuration, even when a pre-registered user does not have a terminal capable of making a payment, the user is enabled to use a service to make a payment with a terminal of an agent. For example, a person who has no mobile terminal, such as a smartphone, is not able to use a payment service on a network. The payment service server 11 executes a process of enabling a person who has no mobile terminal to make a payment with another mobile terminal of an agent by registering the person as a user in advance.

The vehicle allocation scheduling server 12, for example, receives vehicle allocation request information for transporting a transport object, for example, a person or an article, from a pre-registered user and creates a vehicle allocation schedule, and then distributes the created vehicle allocation schedule to a vehicle to be allocated. The vehicle allocation scheduling server 12 manages allocation of vehicles by collecting various pieces of information about allocation of vehicles and storing the information as a database. Examples of the various pieces of information to be stored include information collected from users, and vehicle information collected from vehicles. Examples of the information collected from users include user data, a purpose of use, booking data (including a point of dispatch that is a transport source, a point of destination that is a transport destination, desired dispatch date and time, and the like), cancellation history (cancellation dates and times, and the like), questionnaire result (satisfaction rating), and the like. For the information collected from users, information collectable from these pieces of information is collected and stored. Examples of the information collected from vehicles include an operation history including dispatch instruction received time, a point of dispatch, a point of destination, pick-up date and time (dispatch completion date and time), drop-off date and time (arrival date and time), and the like. For the information collected from vehicles, information collectable from these pieces of information is collected and stored.

The operation management server 14 manages the operation status of vehicles including taxis 26, buses 28, and the like by collecting various pieces of collectable vehicle information and storing the vehicle information as a database. Examples of the various pieces of vehicle information to be collected from vehicles include position information, destination information, information on freight and passenger status, region information indicating an operating region, travel data, driving operation data, remaining energy data, and door and other equipment movement data of vehicles. For the vehicle information, information collectable from vehicles is collected from vehicles and stored.

Each of the client terminals 18 functions as an interface for accessing servers, such as cloud servers, that provide various services and receiving various services provided by the servers. In the present embodiment, each client terminal 18 functions as an interface for accessing the vehicle allocation scheduling server 12 to receive a vehicle allocation service provided by the vehicle allocation scheduling server 12 or accessing the payment service server 11 to receive a payment service provided by the payment service server 11. Specifically, the client terminal 18, for example, makes a request to the vehicle allocation scheduling server 12 to transport a person or an article. The client terminal 18 generates transport request information containing the positions of transport source and transport destination and sends the transport request information to the vehicle allocation scheduling server 12 in response to user's operation. When a user who uses the client terminal 18 makes a request for allocation of a vehicle, the client terminal 18 executes a process of making a payment for the user. For example, as shown in FIG. 1, the client terminal 18 may be a personal computer 18a or may be a mobile terminal 18b, such as a smartphone and a tablet terminal, or may be an internet TV or the like. When the mobile terminal 18b is applied, the mobile terminal 18b is connected to the communication network 22 via a wireless relay station 24.

The vehicle-side terminal 20 is installed in each of vehicles for allocation, such as taxis 26 and buses 28. The vehicle-side terminal 20 has a function of sending vehicle information containing vehicle position information to the operation management server 14, a function of receiving a vehicle allocation schedule created by the vehicle allocation scheduling server 12, and the like. For example, as shown in FIG. 1, the vehicle-side terminal 20 may be the mobile terminal 20a, such as a smartphone and a tablet terminal, or may be a dedicated in-vehicle device 20b equipped with a telephone conversation function, a communication function of transmitting and receiving information, and the like. For example, a dedicated in-vehicle device termed a data communication module (DCM) may be applied as the dedicated in-vehicle device 20b.

Next, the configuration of the main part of the electrical system of each of the vehicle allocation scheduling server 12, the payment service server 11, the operation management server 14, the client terminal 18, and the vehicle-side terminal 20 in the information processing system 10 according to the present embodiment will be described.

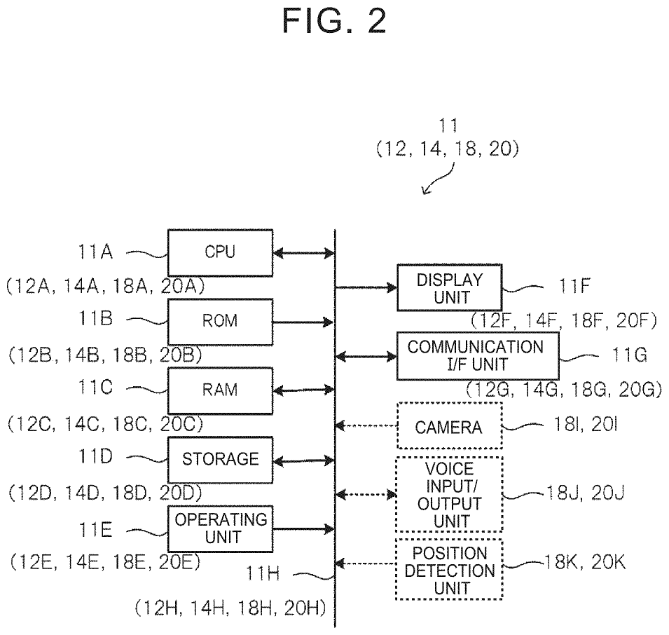

FIG. 2 is a block diagram showing the configuration of the main part of the electrical system of each of the payment service server 11, the vehicle allocation scheduling server 12, the operation management server 14, the client terminal 18, and the vehicle-side terminal 20. The payment service server 11, the vehicle allocation scheduling server 12, the operation management server 14, the client terminal 18, and the vehicle-side terminal 20 each basically have a general computer configuration, so the payment service server 11 will be described as a representative here.

As shown in FIG. 2, the payment service server 11 includes a central processing unit (CPU) 11A, a read only memory (ROM) 11B, a random access memory (RAM) 11C, a storage 11D, an operating unit 11E, a display unit 11F, and a communication interface (I/F) unit 11G.

The CPU 11A is a central processing unit that functions as a reception unit, a processing unit, and a preprocessing unit and governs the operation of the whole apparatus by executing various programs. Various control programs, various parameters, and the like, are prestored in the ROM 11B. The RAM 11C is used as a work area or the like when the CPU 11A executes various programs. The storage 11D is made up of at least any one of various storage units, such as a hard disk drive (HDD), a solid state drive (SSD), and a flash memory. Various pieces of data, application programs, and the like are stored in the storage 11D. The operating unit 11E is made up of at least any one of a keyboard, a mouse, a touch panel, and the like and is used to input various pieces of information. The display unit 11F is used to display various pieces of information. The communication I/F unit 11G is capable of connecting with the communication network 22 such as a LAN, a WAN, and the Internet, and sending and receiving various data to and from another apparatus connected to the communication network 22. The units of the above-described payment service server 11 are electrically connected to one another by a system bus 11H.

With the above configuration, the payment service server 11 uses the CPU 11A to access the ROM 11B, the RAM 11C, and the storage 11D, to acquire various pieces of data via the operating unit 11E, and to display various pieces of information on the display unit 11F. The payment service server 11 uses the CPU 11A to control send and receive of communication data via the communication I/F unit 11G.

As represented by the dashed lines in FIG. 2, the client terminal 18 further includes a camera 18I as a photographing unit, a voice input/output unit 18J, a position detection unit 18K, and the like, and the vehicle-side terminal 20 further includes a camera 20I as a photographing unit, a voice input/output unit 20J, a position detection unit 20K, and the like.

The cameras 18I, 20I generate image data representing a moving image or a still image by taking a moving image or a still image.

The voice input/output units 18J, 20J output voice from a speaker, a headphone, or the like, and inputs voice by collecting sound with a microphone or the like and generate voice information representing the input voice.

The position detection unit 18K detects current position information of the client terminal 18. The position detection unit 20K detects current position information of the vehicle-side terminal 20. For example, the position detection units 18K, 20K receives radio waves from global positioning system (GPS) satellites and determine the position of one point in a space based on distances from the three or more GPS satellites.

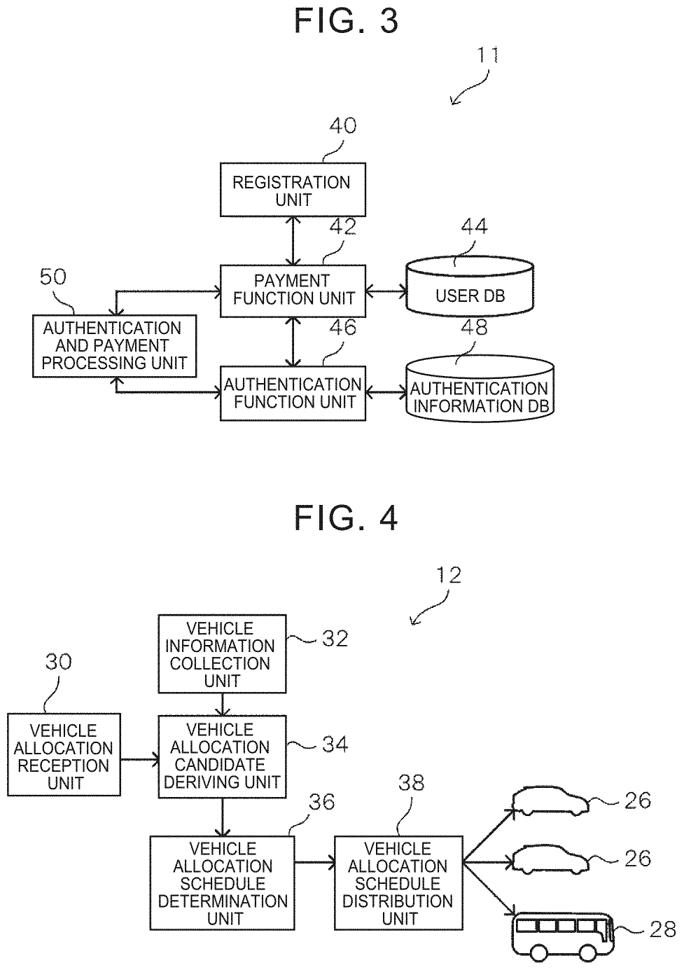

Next, examples of functions that are executed when the CPU 11A of the payment service server 11 expands programs stored in the ROM 11B onto the RAM 11C and runs the programs will be described. FIG. 3 is a functional block diagram showing the functional configuration of the payment service server 11 according to the present embodiment.

As shown in FIG. 3, the payment service server 11 has the functions of a registration unit 40, a payment function unit 42, a user database (DB) 44, an authentication function unit 46, an authentication information DB 48, and an authentication and payment processing unit 50. The authentication and payment processing unit 50 corresponds to a reception unit and a processing unit.

The registration unit 40 receives user registration information for using the payment service provided by the payment service server 11. The registration unit 40, for example, receives user registration information input by user operation of the client terminal 18. The registration unit 40 receives information, such as the mail address of an e-mail, address, name, age, sex, and face photograph, as user registration information. The registration unit 40, for example, upon receiving user registration information, makes a request to the payment function unit 42 for payment registration and, after registration, returns a user registration completion notification to the client terminal 18. When a user is authenticated by using an authentication code, such as a two-dimensional barcode and a barcode as an example of an authentication code, an authentication code for authenticating a user is generated and returned together with a user registration completion notification at the time of returning a user registration completion notification to the client terminal 18.

When the registration unit 40 receives user registration information and performs user registration, the payment function unit 42 stores the user registration information in the user DB 44 as payment user information. The payment function unit 42 executes, for example, a process of making a request to the authentication function unit 46 to register authentication information and, upon receiving an authentication registration completion notification, sending a user registration completion notification to the registration unit 40. The payment function unit 42 determines whether the user is registered in the user DB 44 based on the payment user information stored in the user DB 44 in response to a request for a payment process, and performs a payment process for the determined user. In the present embodiment, user information is stored in the user DB 44 as payment user information; however, user information and payment user information may be different from each other. For example, all of pieces of information such as the mail address of an e-mail, address, name, age, sex, and face photograph may be registered as payment user information or part of information needed for payment may be registered as payment user information.

When the payment function unit 42 makes a request to the authentication function unit 46 for registration of authentication information and the authentication function unit 46 performs user registration, the authentication function unit 46 executes a process of storing the authentication information in the authentication information DB 48 and sending an authentication registration completion notification to the payment function unit 42. The authentication function unit 46, for example, checks whether a user making an authentication request is a user registered in the authentication information DB 48 and returns an authentication result. User ID, face photograph, and the like needed for authentication in user registration information or payment registration information are registered as authentication information.

The authentication and payment processing unit 50 executes a process of receiving a payment request containing user information from the client terminal 18, causing the authentication function unit 46 to authenticate a user, and, when the user is authenticated, causing the payment function unit 42 to perform a payment process. In the present embodiment, the authentication and payment processing unit 50 receives user information from the client terminal 18 equipped with a payment function and used by a first user and, when a second user different from the first user is authenticated, performs a payment process for the second user. When the authentication and payment processing unit 50 receives a payment request from the client terminal 18, the authentication and payment processing unit 50 may further receive the position information of the client terminal 18. With this configuration, it is possible to acquire the position of a user as a history at the time of payment and use the history as information to track fraud.

Next, examples of functions that are executed when the CPU 12A of the vehicle allocation scheduling server 12 expands programs stored in the ROM 12B onto the RAM 12C and runs the programs will be described. FIG. 4 is a functional block diagram showing the functional configuration of the vehicle allocation scheduling server 12 according to the embodiment.

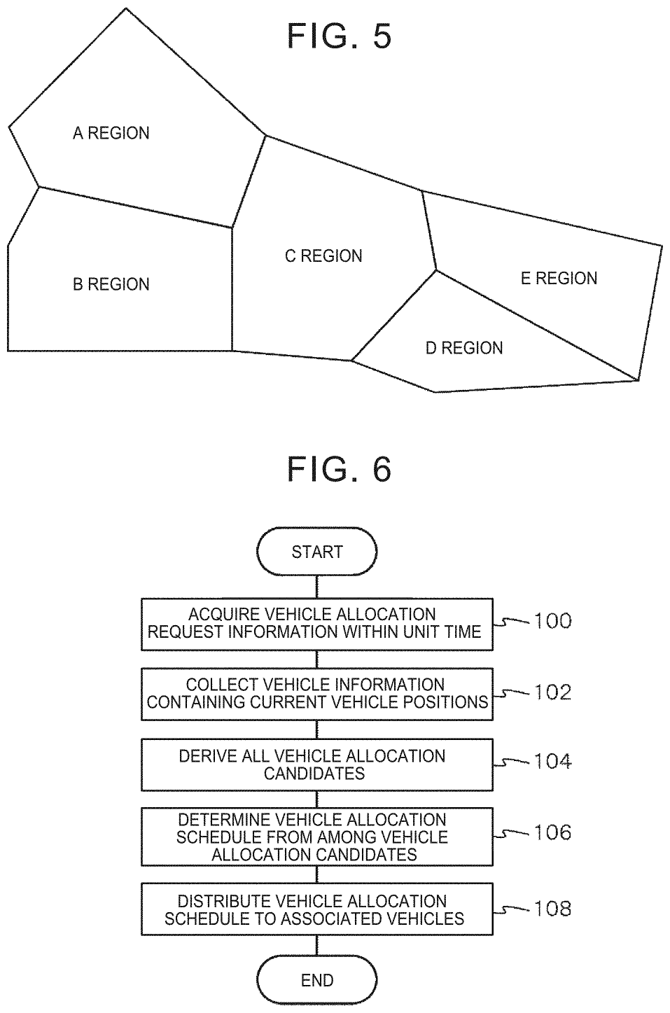

As shown in FIG. 4, the vehicle allocation scheduling server 12 has the functions of a vehicle allocation reception unit 30, a vehicle information collection unit 32, a vehicle allocation candidate deriving unit 34, a vehicle allocation schedule determination unit 36, and a vehicle allocation schedule distribution unit 38. When the vehicle allocation scheduling server 12 receives vehicle allocation request information indicating a request for transport of freight and passengers from the client terminal 18, the vehicle allocation scheduling server 12 creates a vehicle allocation schedule for a plurality of vehicles covering a plurality of regions from a point of departure to a point of destination and distributes the vehicle allocation schedule to each vehicle. With this configuration, it is possible to transport freight and passengers in a wider range including a plurality of regions. When there is a plurality of operation areas of vehicles, such as taxis 26 and shared buses 28, the operation areas partially border or overlap, and an operation area is designated for each company, an operation schedule is created in consideration of take-over or the like of freight and passengers. Specifically, in the case where a purchased product is delivered, when there is a plurality of operation areas of taxis 26 and buses 28 from a shop where the product for which a user requests for delivery is stored to a delivery destination, a vehicle allocation schedule is created such that the product is handed over in partial areas of the operation areas within a predetermined time range (for example, 16:00 to 16:10 or the like). When, for example, the operation areas of taxis 26 and buses 28 are respectively designated in advance for A to E regions shown in FIG. 5, a vehicle allocation schedule is created such that a product is handed over in partial areas where the regions border. Regarding operation areas of taxis 26, each vehicle allocation schedule may be determined in consideration of flow of people and physical distribution, for example, a taxi 26 transports a person on the way and transports a product for delivery on the way back beyond the operation area.

The vehicle allocation reception unit 30 receives from the client terminal 18 dispatch request information at least containing the position of the point of departure of freight and passengers as a transport source and the position of a point of destination as a transport destination. In other words, the vehicle allocation reception unit 30 receives dispatch request information by receiving dispatch request information input by a user operating the client terminal 18 via the communication network 22.

The vehicle information collection unit 32 collects information about vehicles for allocation in taxi companies, bus companies, and the like in each pre-registered region via the operation management server 14. In other words, in the present embodiment, the operation management server 14 collects vehicle information about each of vehicles for allocation, and the vehicle information collection unit 32 acquires the vehicle information collected by the operation management server 14. The vehicle information collection unit 32 acquires information such as vehicle position information, destination information, information on freight and passenger status, and region information indicating an operation region from the operation management server 14 via the communication network 22 as vehicle information.

The vehicle allocation candidate deriving unit 34 derives a vehicle allocation candidate containing designated vehicles and routes based on the dispatch request information received by the vehicle allocation reception unit 30 and the vehicle information collected by the vehicle information collection unit 32. For example, the vehicle allocation candidate deriving unit 34 derives all the dispatch candidate vehicles and all the dispatch candidate routes from the point of departure to the point of destination, contained in the dispatch request information, as dispatch candidates. The vehicle allocation candidate deriving unit 34 also derives information for determining a dispatch candidate, such as travel distance and completion time, for each of the dispatch candidates. When the vehicle allocation candidate deriving unit 34 applies a taxi 26 as a dispatch candidate vehicle, and in the case where a transport object is an article, the vehicle allocation candidate deriving unit 34 may derive a vehicle allocation candidate such that a taxi transports a person beyond the region of a transport source and, when the taxi returns from a transport destination to the region of the transport source, a transport object is limited to an article. With this configuration, even when the operation area of a taxi company is designated, people can be transported as in the case of an ordinary operation, and articles can be transported to a wide range.

The vehicle allocation schedule determination unit 36 determines a vehicle allocation schedule from among the vehicle allocation candidates derived by the vehicle allocation candidate deriving unit 34. More specifically, the vehicle allocation schedule determination unit 36 determines a vehicle allocation schedule such that vehicles are located in partial areas where a plurality of regions borders within a predetermined time range. Specifically, when vehicles respectively having designated operation areas, such as taxis 26 and buses 28, are included as dispatch candidates, the vehicle allocation schedule determination unit 36 determines a vehicle allocation schedule such that vehicles are located in partial areas where a plurality of regions borders within a predetermined time range. When a plurality of vehicle allocation candidates is derived by the vehicle allocation candidate deriving unit 34, the vehicle allocation schedule determination unit 36 determines the vehicle allocation candidate that satisfies predetermined conditions as a vehicle allocation schedule.

The vehicle allocation schedule distribution unit 38 distributes a vehicle allocation schedule to the vehicle-side terminal 20 of each of vehicles, such as taxis 26 and buses 28, included in the vehicle allocation schedule determined by the vehicle allocation schedule determination unit 36. In other words, the vehicle allocation schedule distribution unit 38 sends the vehicle allocation schedule to each vehicle for allocation via the communication network 22. A vehicle allocation schedule may be directly distributed to each vehicle from the vehicle allocation scheduling server 12 via the communication network 22 or may be distributed to each vehicle via the operation management server 14. With this configuration, the vehicle-side terminal 20 of each vehicle receives a vehicle allocation schedule, and an operation according to the vehicle allocation schedule can be performed by a driver of the vehicle. When a vehicle allocation schedule is distributed from the operation management server 14 to each vehicle, the vehicle allocation schedule may be provided to a driver by using a radio or the like other than via the communication network 22.

Subsequently, specific processes to be executed in the thus configured units of the information processing system 10 according to the present embodiment will be described.

First, a specific process to be executed in the vehicle allocation scheduling server 12 will be described. FIG. 6 is a flowchart showing an example of a process to be executed by the vehicle allocation scheduling server 12 of the information processing system 10 according to the present embodiment. The process of FIG. 6 is executed, for example, each time a predetermined unit time (for example, one to three hours or the like) elapses.

In step 100, the CPU 12A acquires vehicle allocation request information within a predetermined unit time and then advances to step 102. In the present embodiment, the vehicle allocation scheduling server 12 does not create a vehicle allocation schedule each time the vehicle allocation scheduling server 12 receives vehicle allocation request information. In order for the vehicle allocation scheduling server 12 to accumulate vehicle allocation requests for a predetermined unit time (for example, one to three hours or the like) and create a vehicle allocation schedule for each unit time, the vehicle allocation reception unit 30 acquires vehicle allocation requests within the unit time.

In step 102, the CPU 12A collects vehicle information containing current vehicle positions and then advances to step 104. In other words, the vehicle information collection unit 32 collects information about vehicles for allocation in taxi companies, bus companies, and the like in each pre-registered region via the operation management server 14. In the present embodiment, the vehicle information collection unit 32 acquires the vehicle information collected by the operation management server 14.

In step 104, the CPU 12A derives all the vehicle allocation candidates and then advances to step 106. In other words ,the vehicle allocation candidate deriving unit 34 derives vehicle allocation candidates based on the dispatch request information received by the vehicle allocation reception unit 30 and the vehicle information collected by the vehicle information collection unit 32. For example, the vehicle allocation candidate deriving unit 34 derives all the dispatch candidate vehicles and all the dispatch candidate routes from the point of departure to the point of destination, contained in the dispatch request information, as dispatch candidates. The vehicle allocation candidate deriving unit 34 derives information for determining a dispatch candidate, such as travel distance and completion time, for each of the dispatch candidates. When the vehicle allocation candidate deriving unit 34 applies taxis 26 as dispatch candidate vehicles and derives dispatch candidates, the vehicle allocation candidate deriving unit 34 may derive dispatch candidates such that a taxi transports a person beyond the operation region of a transport source and, when the taxi returns from a transport destination to the region of the transport source, a transport object is limited to an article. With this configuration, even when the operation area of a taxi company is designated, people can be transported as in the case of an ordinary operation, and articles can be transported to a wide range.

In step 106, the CPU 12A determines a vehicle allocation schedule from among the vehicle allocation candidates derived by the vehicle allocation candidate deriving unit 34 and then advances to step 108. In other words, the vehicle allocation schedule determination unit 36 determines a vehicle allocation schedule by determining a vehicle allocation candidate from among the vehicle allocation candidates derived by the vehicle allocation candidate deriving unit 34. When, for example, vehicles having operation areas, such as taxis 26 and buses 28, are included in a vehicle allocation candidate, a vehicle allocation schedule is created such that vehicles are located in a partial area where a plurality of regions borders within a predetermined time range. When a plurality of vehicle allocation candidates is derived by the vehicle allocation candidate deriving unit 34, the vehicle allocation schedule determination unit 36 determines a vehicle allocation candidate that satisfies a predetermined condition as a vehicle allocation schedule. A condition that a delivery time is shortest, a condition that a delivery distance is shortest, a condition that the number of vehicles to be allocated is smallest, or the like may be applied as the predetermined condition.

In step 108, the CPU 12A distributes the vehicle allocation schedule to the associated vehicles and ends the series of processes. In other words, the vehicle allocation schedule distribution unit 38 distributes the vehicle allocation schedule to the vehicle-side terminal 20 of each of vehicles, such as taxis 26 and buses 28, included in the vehicle allocation schedule determined by the vehicle allocation schedule determination unit 36. With this configuration, the vehicle-side terminal 20 of each vehicle receives a vehicle allocation schedule, and an operation according to the vehicle allocation schedule can be performed by a driver of the vehicle. Thus, it is possible to perform transportation using vehicles in a plurality of regions in cooperation with one another, so it is possible to transport freight and passengers in a wide range.

In the process of FIG. 6, an example in which the vehicle allocation scheduling server 12 creates a vehicle allocation schedule for vehicle allocation requests in each predetermined unit time is described; however, the configuration is not limited thereto. For example, the vehicle allocation scheduling server 12 may be configured to create a vehicle allocation schedule each time the vehicle allocation scheduling server 12 receives vehicle allocation request information.

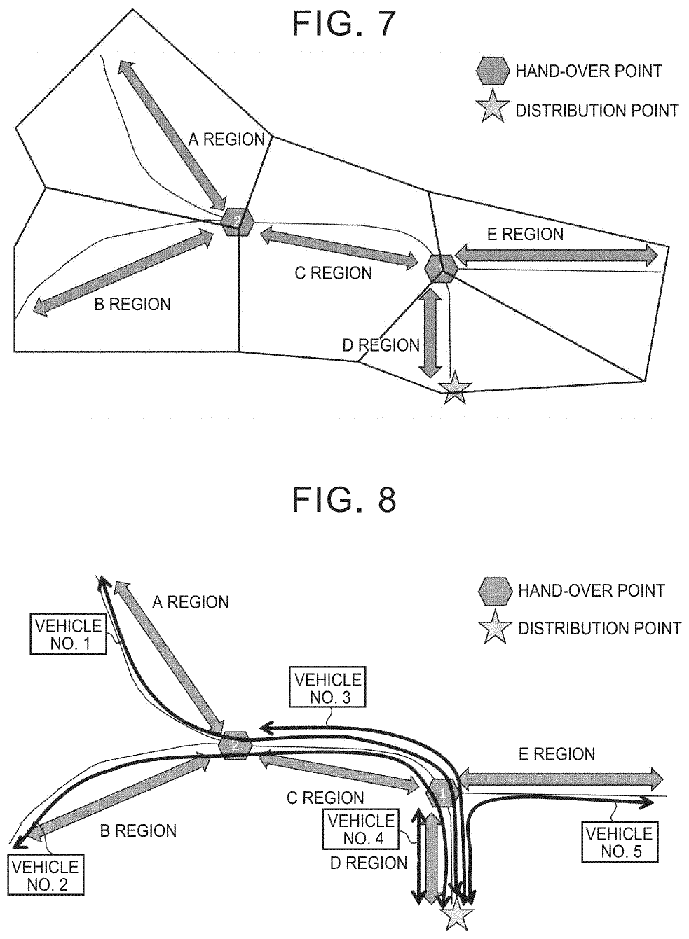

Next, a vehicle allocation schedule to be created by the vehicle allocation scheduling server 12 of the information processing system 10 according to the present embodiment will be described by way of one example. FIG. 7 is a view for illustrating a precondition for an example of a vehicle allocation schedule.

For example, as shown in FIG. 7, the case where products are delivered from a shop to A to E regions on which a vehicle allocation schedule is created will be described. In the example of FIG. 7, it is assumed that the star mark in D region is a distribution point to start delivery and a partial area where C to E regions border and a partial area where A to C regions border are respectively a hand-over point 1 and a hand-over point 2.

The vehicle allocation scheduling server 12 basically schedules vehicle allocation in accordance with the amount of delivery requests per unit time in each of A to E regions.

The amount of baggage to be transported has such a relationship that D region>C region>A, B, and E regions, so the vehicle allocation schedule is adjusted depending on the transport amount such that vehicles in C region and E region are additionally allocated to a section in D region and vehicles in sections of A region and B region are additionally allocated to a section in C region. With this configuration, it is possible to flexibly deal with a change in transport amount. When a vehicle in a region other than a point of departure is additionally allocated, the vehicle allocation schedule is adjusted including adjustment of vehicles to be allocated and adjustment of delivery start time from a distribution point such that the vehicle to be allocated is located at a hand-over point as a partial area where regions border within a predetermined time range.

At the time of receiving delivery of products, a take-over waiting time is optimized by adjusting available delivery booking time in each region. For example, at the time of receiving vehicle allocation request information, available delivery booking time for each region is adjusted by providing the available delivery booking time to a user, and reception of a delivery request earlier in time than the provided available delivery booking time is disabled. For example, in the example of FIG. 7, the available delivery booking time of each region is adjusted such that the order of D region→E region, C region→A region, B region holds. Thus, a take-over waiting time at each hand-over point is reduced.

It is assumed that there are four requests for A region, three requests for B region, three requests for C region, five request for D region, and two requests for E region. As a precondition, it is assumed that a distance (section main track) is set such that, where the distance of D section is 1, the distance of A section is 2, the distance of B section is 1.5, the distance of C section is 1.5, and the distance of E section is 2.5. It is also assumed that the number of vehicles is five as available vehicles and the maximum transport amount per one vehicle is four seats or eight pieces (two pieces per one seat). It is assumed that a travel time per 1 distance is 30, a delivery time (a time from travel to hand over) per one piece is 10, and a hand-over/take-over time per one piece is 1.

It is assumed as usage constraints that a user is informed of an available delivery time period in which five vehicles can be operated at the time of a delivery request and a delivery in a time period other than the available delivery time period is not accepted.

In accordance with the above predetermined precondition and usage constraints, the vehicle allocation candidate deriving unit 34 of the vehicle allocation scheduling server 12 derives a plurality of vehicle allocation candidates for which vehicles and routes to transport are designated.

Specifically, the vehicle allocation candidate deriving unit 34 initially creates a delivery schedule in which each vehicle does not perform delivery or hand over in a plurality of sections, as a reference schedule plan that is a reference for vehicle allocation candidates. FIG. 8 is a view for illustrating a reference schedule plan for a vehicle allocation candidate.

In the basic reference schedule plan, a vehicle that delivers in order of D region, C region, and A region is assumed as vehicle number 1, and the vehicle number 1 loads four pieces at the distribution point and delivers the four pieces in A region.

A vehicle that delivers in order of D region, C region, and B region is assumed as vehicle number 2, and the vehicle number 2 loads three pieces at the distribution point and delivers the three pieces in B region.

A vehicle that delivers in order of D region and C region is assumed as vehicle number 3, and the vehicle number 3 loads three pieces at the distribution point and delivers the three pieces in C region.

A vehicle that delivers in D region is assumed as vehicle number 4, and the vehicle number 4 loads five pieces at the distribution point and delivers the five pieces in D region.

A vehicle that delivers in order of D region and E region is assumed as vehicle number 5, and the vehicle number 5 loads two pieces at the distribution point and delivers the two pieces in E region.

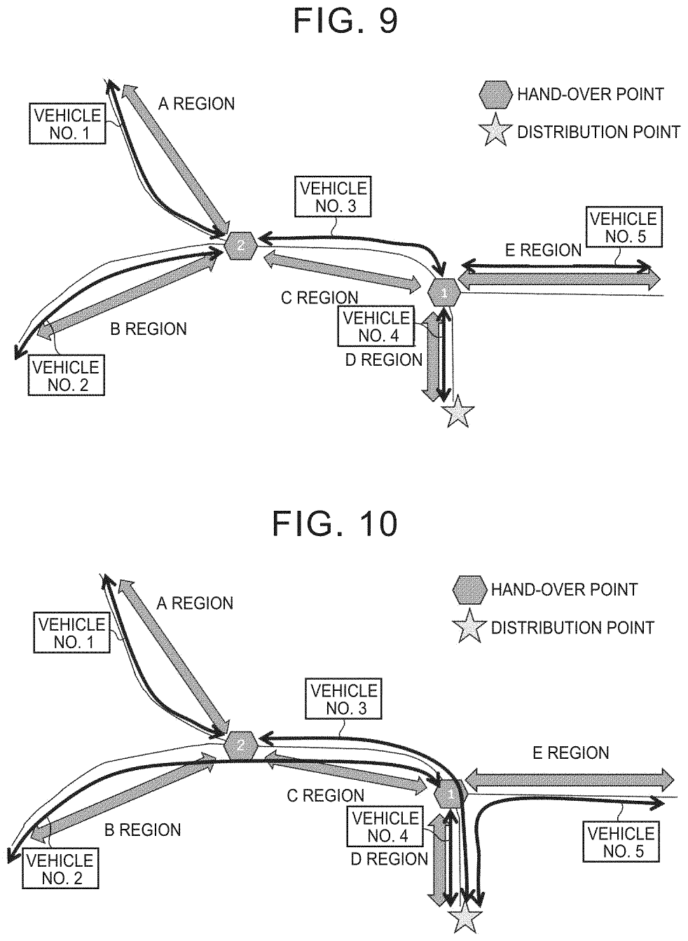

Next, the vehicle allocation candidate deriving unit 34 schedules vehicle allocation as a first plan for a vehicle allocation candidate such that vehicles each transport only in a section and hand over at a hand-over point. FIG. 9 is a view for illustrating the first plan for a vehicle allocation candidate.

In the first plan, a vehicle that delivers in A region is assumed as vehicle number 1, a vehicle that delivers in B region is assumed as vehicle number 2, a vehicle that delivers in C region is assumed as vehicle number 3, a vehicle that delivers in D region is assumed as vehicle number 4, and a vehicle that delivers in E region is assumed as vehicle number 5.

The vehicle number 1 takes over four pieces from the vehicle number 3 at the hand-over point 2 and delivers four pieces in A region. The vehicle number 2 takes over three pieces from the vehicle number 3 at the hand-over point 2 and delivers three pieces in B region. The vehicle number 3 takes over 10 pieces from the vehicle number 4 at the hand-over point 1 and delivers three pieces in C region, and also moves to the hand-over point 2 and hands over four pieces to the vehicle number 1 and three pieces to the vehicle number 2. The vehicle number 4 loads 17 pieces at the distribution point, delivers five pieces in D region and moves to the hand-over point 1, and hands over 10 pieces to the vehicle number 3 and two pieces to the vehicle number 5. The vehicle number 5 takes over two pieces from the vehicle number 4 at the hand-over point 1 and delivers two pieces in E region.

In the first plan, the total transport in D region is 17, and 17/8>2, so it appears that this plan does not hold. In addition, it appears from the total amount of transport share that three or more vehicles need to run in the section of D region and two or more vehicles need to run in the section of C region.

Subsequently, the vehicle allocation candidate deriving unit 34 schedules vehicle allocation as a second plan for a vehicle allocation candidate such that the transport share of the vehicle number 4 is distributed to the vehicles in the section of E region and the section of C region that are sections adjoining D region in the first plan and the transport share of the vehicle number 3 is distributed to the vehicle in B region that is the section adjoining C region. FIG. 10 is a view for illustrating the second plan for a vehicle allocation candidate. In the second plan, when there is a plurality of adjoining sections, similar distribution is performed in all the adjoining sections. However, when the maximum transport amount is exceeded, such an adjoining section is excluded. The case of FIG. 10 shows an example in which the transport share is distributed to a vehicle number 2.

In the second plan, a vehicle that delivers in A region is assumed as vehicle number 1, a vehicle that delivers in order of C region and B region is assumed as vehicle number 2, a vehicle that delivers in order of D region and C region is assumed as vehicle number 3, a vehicle that delivers in D region is assumed as vehicle number 4, and a vehicle that delivers in order of D region and E region is assumed as vehicle number 5.

The vehicle number 1 takes over four pieces from the vehicle number 3 at the hand-over point 2 and delivers four pieces in A region. The vehicle number 2 takes over three pieces from the vehicle number 5 at the hand-over point 1 and delivers three pieces in B region. The vehicle number 3 loads seven pieces at the distribution point, delivers three pieces in C region and moves to the hand-over point 2, and hands over four pieces to the vehicle number 1. The vehicle number 4 loads five pieces at the distribution point and delivers five pieces in D region. The vehicle number 5 loads five pieces at the distribution point, moves to the hand-over point 1, hands over three pieces to the vehicle number 2, and then delivers two pieces in E region.

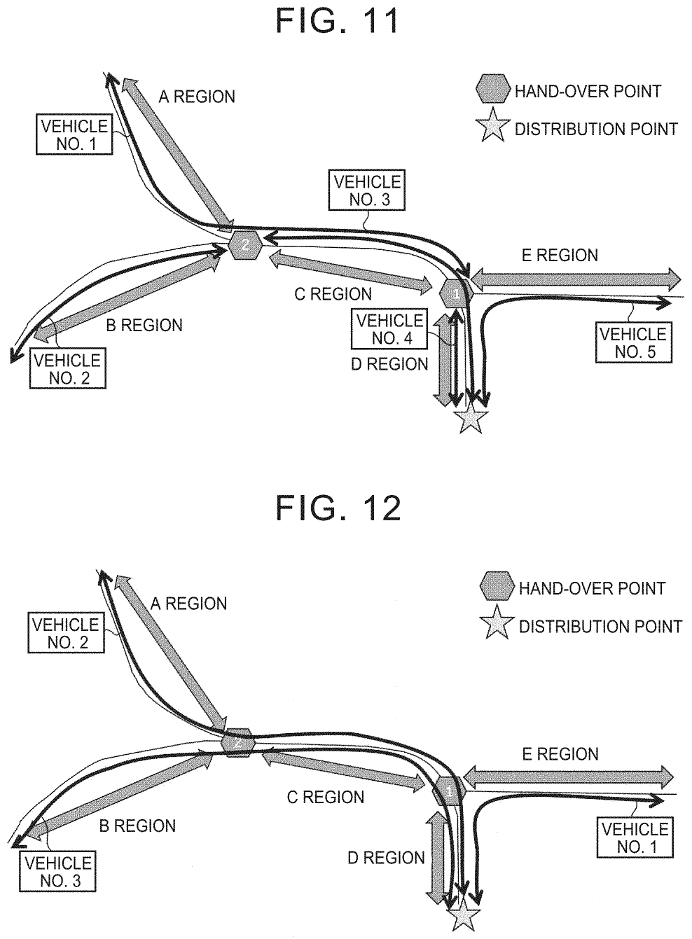

Subsequently, the vehicle allocation candidate deriving unit 34 schedules vehicle allocation as a third plan for a vehicle allocation candidate such that the transport share of the vehicle number 4 is distributed to the vehicles in the section of E region and the section of C region that are sections adjoining D region in the first plan and the transport share of the vehicle number 3 is distributed to the vehicle in A region that is a section adjoining C region, as in the case of the second plan. FIG. 11 is a view for illustrating the third plan for a vehicle allocation candidate.

In the third plan, a vehicle that delivers in order of C region and A region is assumed as vehicle number 1, a vehicle that delivers in B region is assumed as vehicle number 2, a vehicle that delivers in order of D region and C region is assumed as vehicle number 3, a vehicle that delivers in D region is assumed as vehicle number 4, and a vehicle that delivers in order of D region and E region is assumed as vehicle number 5.

The vehicle number 1 takes over four pieces from the vehicle number 5 at the hand-over point 1 and delivers four pieces in A region. The vehicle number 2 takes over three pieces from the vehicle number 3 at the hand-over point 2 and delivers three pieces in B region. The vehicle number 3 loads six pieces at the distribution point, delivers three pieces in C region and moves to the hand-over point 2, and hands over three pieces to the vehicle number 2. The vehicle number 4 loads five pieces at the distribution point and delivers five pieces in D region. The vehicle number 5 loads five pieces at the distribution point, moves to the hand-over point 1, hands over four pieces to the vehicle number 1, and then delivers two pieces in E region.

Subsequently, the vehicle allocation candidate deriving unit 34 makes a schedule as a fourth plan for a vehicle allocation candidate when vehicles that pass at least once through all the sections in A to E regions, no hand over occurs even once, the result of distribution to each vehicle does not exceed the maximum transport amount, and there is no vehicle for delivery only in overlapping section (C, D). FIG. 12 is a view for illustrating the fourth plan for a vehicle allocation candidate. FIG. 12 is one example showing a delivery share by which the total number of sections in charge is minimum and the last delivery completion time is the earliest.

A vehicle number 1 loads seven pieces at the distribution point, delivers five pieces in D region, and delivers two pieces in E region. A vehicle number 2 loads four pieces at the distribution point and delivers four pieces in A region. A vehicle number 3 loads six pieces at the distribution point, delivers three pieces in C region, and delivers three pieces in B region.

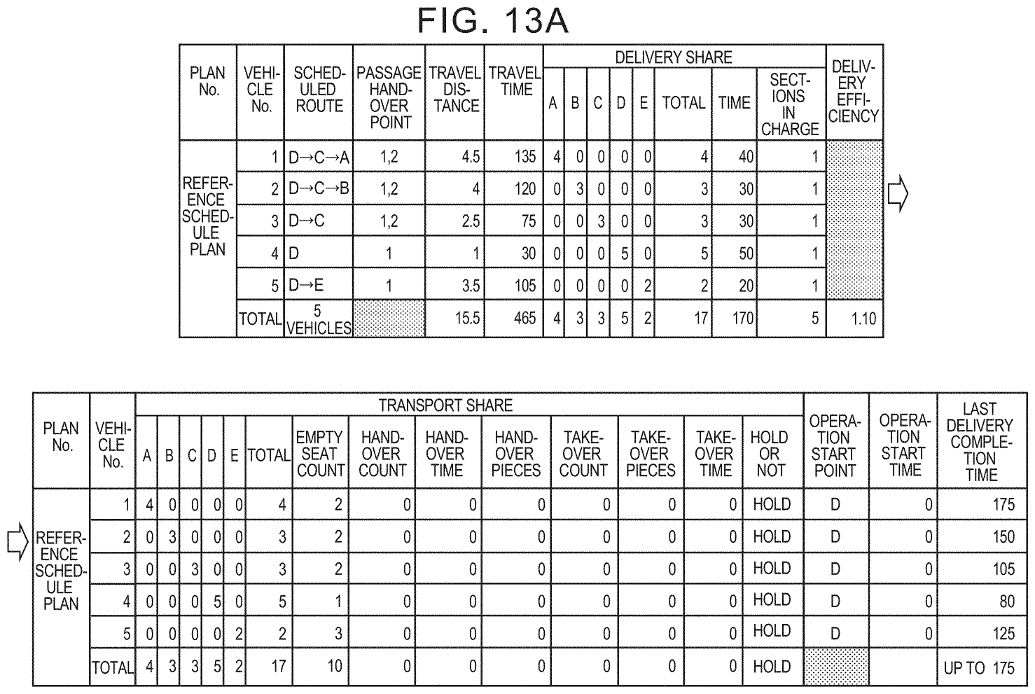

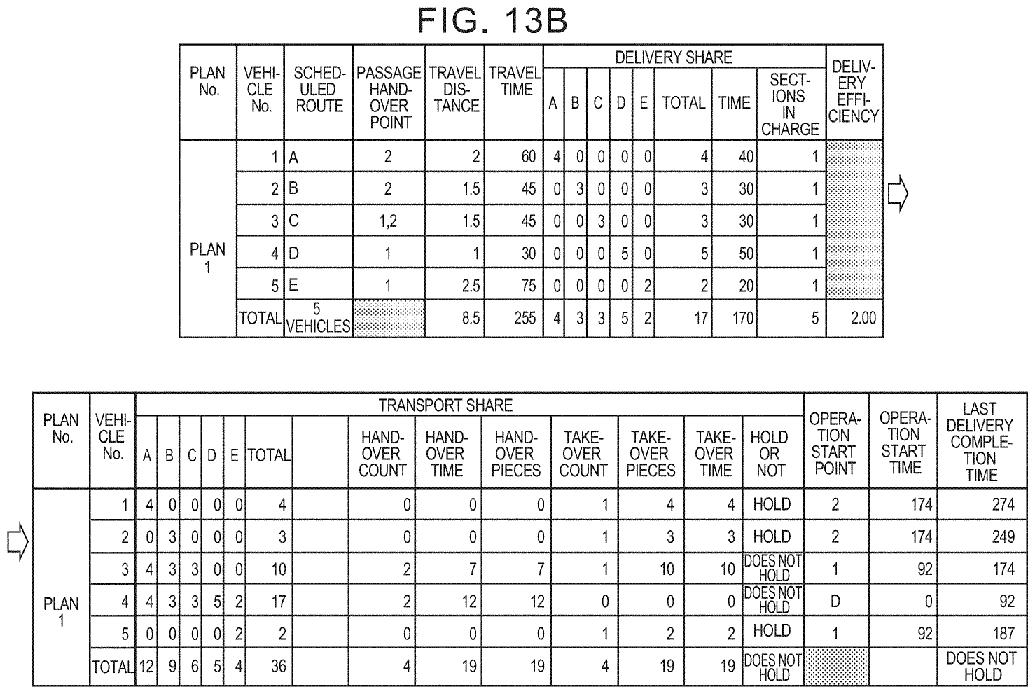

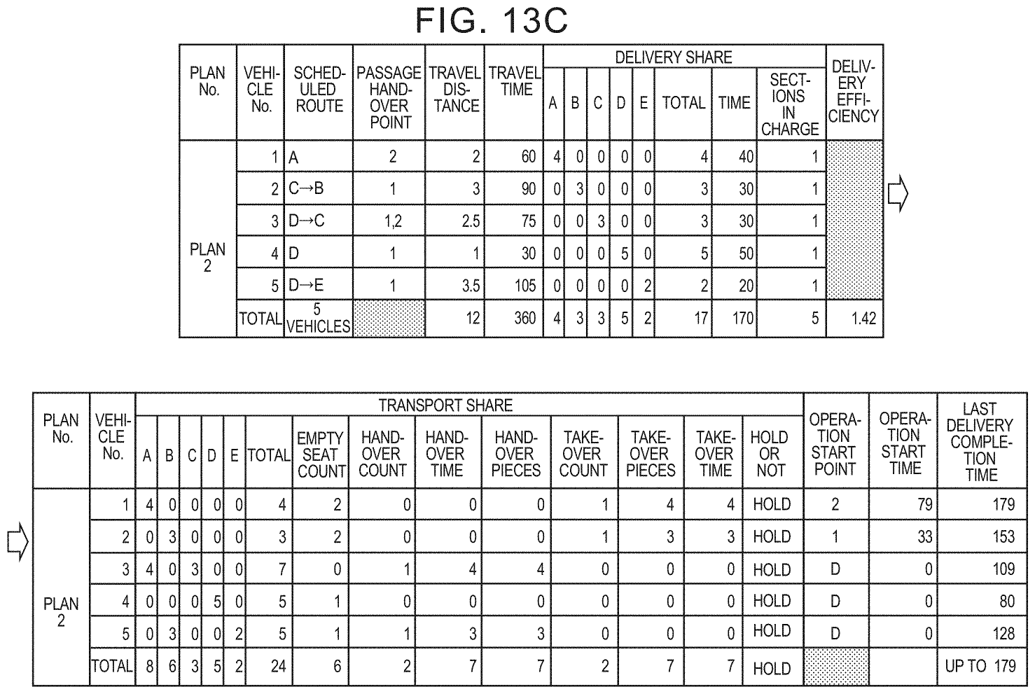

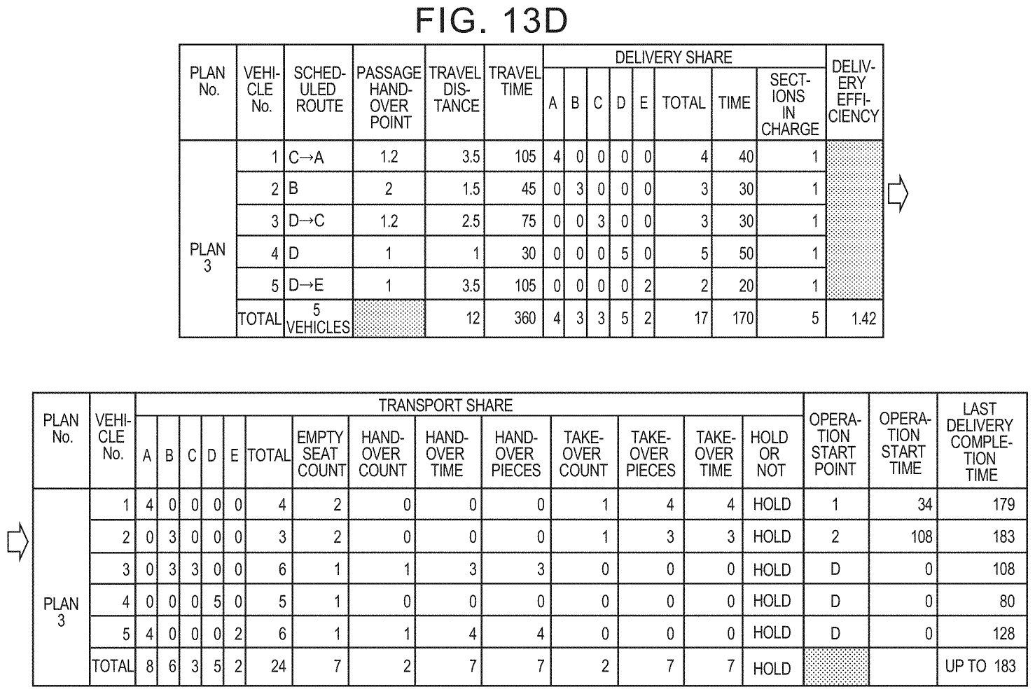

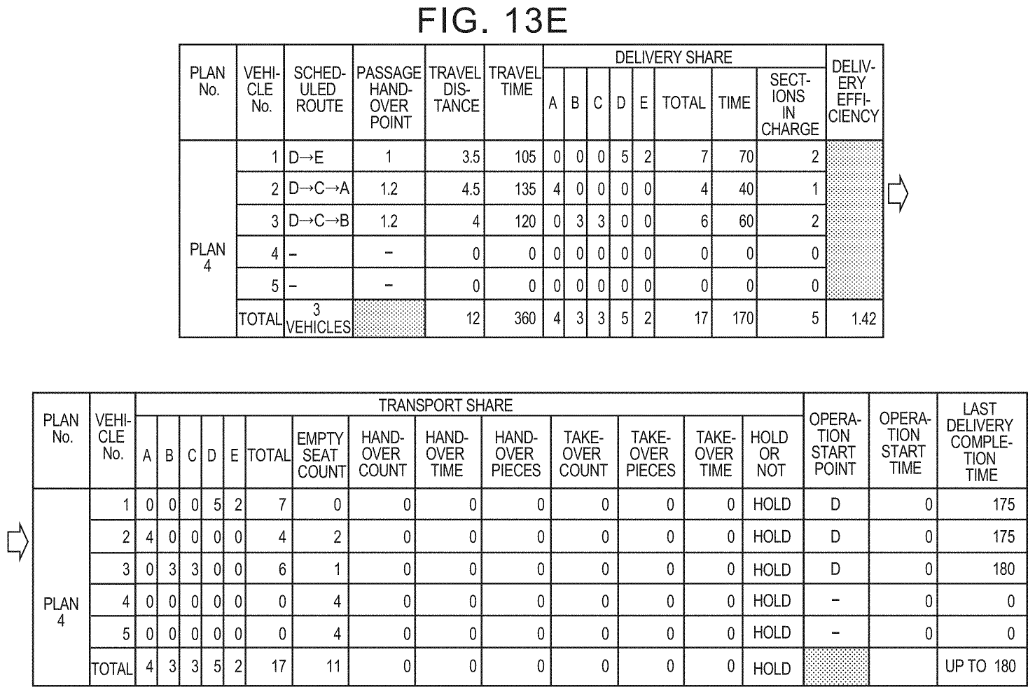

Subsequently, based on the above-described precondition, the vehicle allocation candidate deriving unit 34 derives information for determining a dispatch candidate such as travel distance and completion time for each dispatch candidate. As one example, FIG. 13A, FIG. 13B, FIG. 13C, FIG. 13D and FIG. 13E show results obtained by calculating the details of dispatch candidates of each of the reference schedule plan and first to fourth plans. FIG. 13A, FIG. 13B, FIG. 13C, FIG. 13D and FIG. 13E are tables showing results obtained by calculating the details of dispatch candidates in the reference schedule plan and the first to fourth plans that are vehicle allocation candidates.

In FIG. 13A, FIG. 13B, FIG. 13C, FIG. 13D and FIG. 13E, vehicle No., scheduled route, passage hand-over point, travel distance, travel time, delivery share, delivery efficiency, transport share, travel start point, operation start time, and last delivery completion time are shown as calculation results. A delivery share indicates the amount of delivery in the section of each of A to E regions, and indicates total, time, and the number of sections in charge. A delivery efficiency indicates the amount of delivery per distance and is one of evaluation indices of a schedule plan. A transport share indicates the amount of transport including the amount of hand-over in each of A to E regions, and indicates total, empty seat count, hand-over count, the number of hand-over pieces, take-over time, and hold or not.

More specifically, as shown in FIG. 13A, FIG. 13B, FIG. 13C, FIG. 13D and FIG. 13E, for the vehicle number 1 in the reference schedule plan, the scheduled route is D→C→A, the passage hand-over point is hand-over points 1 and 2, the travel distance is 4.5, the travel time is 135, and the delivery share is such that four in A region and four in total, the time is 40, and the number of sections in charge is one. A transport share is such that four in A region and four in total, the empty seat count is two, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 175.

For the vehicle number 2 of the reference schedule plan, the scheduled route is D→C→B, the passage hand-over point is hand-over points 1 and 2, the travel distance is 4, the travel time is 120, the delivery share is three in B region and three in total, the time is 30, and the number of sections in charge is one. A transport share is such that three in B region and three in total, the empty seat count is two, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 150.

For the vehicle number 3 of the reference schedule plan, the scheduled route is D→C, the passage hand-over point is hand-over points 1 and 2, the travel distance is 2.5, the travel time is 75, the delivery share is three in C region and three in total, the time is 30, and the number of sections in charge is one. A transport share is such that three in C region and three in total, the empty seat count is two, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 105.

For the vehicle number 4 of the reference schedule plan, the scheduled route is D, the passage hand-over point is hand-over point 1, the travel distance is 1, the travel time is 30, the delivery share is five in D region and five in total, the time is 50, and the number of sections in charge is one. A transport share is such that five in D region and five in total, the empty seat count is one, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 80.

For the vehicle number 5 of the reference schedule plan, the scheduled route is D→E, the passage hand-over point is hand-over point 1, the travel distance is 3.5, the travel time is 105, the delivery share is two in E region and two in total, the time is 20, and the number of sections in charge is one. A transport share is such that two in E region and two in total, the empty seat count is three, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 125.

As shown in FIG. 13A, in the reference schedule plan, five vehicles are needed in total, the travel distance is 15.5 in total, the travel time is 465 in total, the delivery share is four in total in A, three in total in B, three in total in C, five in total in D, and two in total in E, and the total delivery share is 17, the total time is 170, the total number of sections in charge is five, and the delivery efficiency is 1.10. A transport share is four in total in A, three in total in B, three in total in C, five in total in D, and two in total in E, and the total number of transport share is 17. In a transport share, the empty seat count is 10 in total, the hand-over count is zero in total, the number of hand-over pieces is zero in total, the hand-over time is zero in total, the take-over count is zero in total, the number of take-over pieces is zero in total, and the take-over time is 0 in total, so the transport share holds, and the last delivery completion time is up to 175.

For the vehicle number 1 of the first plan, the scheduled route is A, the passage hand-over point is hand-over point 2, the travel distance is two, the travel time is 60, the delivery share is four in A region and four in total, the time is 40, and the number of sections in charge is one. A transport share is such that four in A region and four in total, the hand-over count is zero, the number of hand-over pieces is zero, the hand-over time is zero, the take-over count is one, the number of take-over pieces is four, and the take-over time is four, so the transport share holds. The operation start point is hand-over point 2, the operation start time is 174, and the last delivery completion time is 274.

For the vehicle number 2 of the first plan, the scheduled route is B, the passage hand-over point is hand-over point 2, the travel distance is 1.5, the travel time is 45, the delivery share is three in B region and three in total, the time is 30, and the number of sections in charge is one. A transport share is such that three in B region and three in total, the hand-over count is zero, the number of hand-over pieces is zero, the hand-over time is zero, the take-over count is one, the number of take-over pieces is three, and the take-over time is three, so the transport share holds. The operation start point is hand-over point 2, the operation start time is 174, and the last delivery completion time is 249.

For the vehicle number 3 of the first plan, the scheduled route is C, the passage hand-over point is hand-over points 1 and 2, the travel distance is 1.5, the travel time is 45, the delivery share is three in C region and three in total, the time is 30, and the number of sections in charge is one. A transport share is such that four in A region, three in B region, three in C region, and 10 in total, the hand-over count is two, the number of hand-over pieces is seven, the hand-over time is seven, the take-over count is one, the number of take-over pieces is 10, and the take-over time is 10, so the transport share does not hold. The operation start point is hand-over point 1, the operation start time is 92, and the last delivery completion time is 174.

For the vehicle number 4 of the first plan, the scheduled route is D, the passage hand-over point is hand-over point 1, the travel distance is 1, the travel time is 30, the delivery share is five in D region and five in total, the time is 50, and the number of sections in charge is one. A transport share is such that four in A region, three in B region, three in C region, five in D region, two in E region, and 17 in total, the hand-over count is two, the number of hand-over pieces is 12, the hand-over time is 12, the take-over count is zero, the number of take-over pieces is zero, and the take-over time is zero, so the transport share does not hold. The operation start point is D, the operation start time is 0, and the last delivery completion time is 92.

For the vehicle number 5 of the first plan, the scheduled route is E, the passage hand-over point is hand-over point 1, the travel distance is 2.5, the travel time is 75, the delivery share is two in E region and two in total, the time is 20, and the number of sections in charge is one. A transport share is such that two in E region and two in total, the hand-over count is zero, the number of hand-over pieces is zero, the hand-over time is zero, the take-over count is one, the number of take-over pieces is two, and the take-over time is two, so the transport share holds. The operation start point is hand-over point 1, the operation start time is 92, and the last delivery completion time is 187.

As shown in FIG. 13B, in the first plan, five vehicles are needed in total, the travel distance is 8.5 in total, the travel time is 255 in total, the delivery share is four in total in A, three in total in B, three in total in C, five in total in D, and two in total in E, and the total delivery share is 17, the total time is 170, the total number of sections in charge is five, and the delivery efficiency is 2.00. A transport share is 12 in total in A, nine in total in B, six in total in C, five in total in D, and four in total in E, and the total number of transport share is 36. In a transport share, the hand-over count is four in total, the number of hand-over pieces is 19 in total, the hand-over time is 19 in total, the take-over count is four in total, the number of take-over pieces is 19 in total, the take-over time is 19 in total, so the transport share does not hold, and, therefore, the first plan does not hold.

For the vehicle number 1 of the second plan, the scheduled route is A, the passage hand-over point is hand-over point 2, the travel distance is 2, the travel time is 60, the delivery share is four in A region and four in total, the time is 40, and the number of sections in charge is one. A transport share is such that four in A region and four in total, the empty seat count is two, the hand-over count is zero, the number of hand-over pieces is zero, the hand-over time is zero, the take-over count is one, the number of take-over pieces is four, and the take-over time is four, so the transport share holds. The operation start point is hand-over point 2, the operation start time is 79, and the last delivery completion time is 179.

For the vehicle number 2 of the second plan, the scheduled route is C, the passage hand-over point is hand-over point 1, the travel distance is 3, the travel time is 90, the delivery share is three in B region and three in total, the time is 30, and the number of sections in charge is one. A transport share is such that three in B region and three in total, the empty seat count is two, the hand-over count is zero, the number of hand-over pieces is zero, the hand-over time is zero, the take-over count is one, the number of take-over pieces is three, and the take-over time is three, so the transport share holds. The operation start point is hand-over point 1, the operation start time is 33, and the last delivery completion time is 153.

For the vehicle number 3 of the second plan, the scheduled route is D→C, the passage hand-over point is hand-over points 1 and 2, the travel distance is 2.5, the travel time is 75, the delivery share is three in C region and three in total, the time is 30, and the number of sections in charge is one. A transport share is such that four in A region, three in C region, and seven in total, the empty seat count is zero, the hand-over count is one, the number of hand-over pieces is four, the hand-over time is four, the take-over count is zero, the number of take-over pieces is zero, and the take-over time is zero, so the transport share holds. The operation start point is D, the operation start time is 0, and the last delivery completion time is 109.

For the vehicle number 4 of the second plan, the scheduled route is D, the passage hand-over point is hand-over point 1, the travel distance is 1, the travel time is 30, the delivery share is five in D region and five in total, the time is 50, and the number of sections in charge is one. A transport share is such that five in D region and five in total, the empty seat count is one, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 80.

For the vehicle number 5 of the second plan, the scheduled route is D→E, the passage hand-over point is hand-over point 1, the travel distance is 3.5, the travel time is 105, the delivery share is two in E region and two in total, the time is 20, and the number of sections in charge is one. A transport share is such that three in B region, two in E region, and five in total, the empty seat count is one, the hand-over count is one, the number of hand-over pieces is three, the hand-over time is three, the take-over count is zero, the number of take-over pieces is zero, and the take-over time is zero, so the transport share holds. The operation start point is D, the operation start time is 0, and the last delivery completion time is 128.

As shown in FIG. 13C, in the second plan, five vehicles are needed in total, the travel distance is 12 in total, the travel time is 360 in total, the delivery share is four in total in A, three in total in B, three in total in C, five in total in D, and two in total in E, and the total delivery share is 17, the total time is 170, the total number of sections in charge is five, and the delivery efficiency is 1.42. A transport share is eight in total in A, six in total in B, three in total in C, five in total in D, and two in total in E, and the total number of transport share is 24. In a transport share, the empty seat count is six in total, the hand-over count is two in total, the number of hand-over pieces is seven in total, the hand-over time is seven in total, the take-over count is two in total, the number of take-over pieces is seven in total, and the take-over time is 7 in total, so the transport share holds, and the last delivery completion time is up to 179.

For the vehicle number 1 of the third plan, the scheduled route is C→A, the passage hand-over point is hand-over points 1 and 2, the travel distance is 3.5, the travel time is 105, the delivery share is four in A region and four in total, the time is 40, and the number of sections in charge is one. A transport share is such that four in A region and four in total, the empty seat count is two, the hand-over count is zero, the number of hand-over pieces is zero, the hand-over time is zero, the take-over count is one, the number of take-over pieces is four, and the take-over time is four, so the transport share holds. The operation start point is hand-over point 1, the operation start time is 34, and the last delivery completion time is 179.

For the vehicle number 2 of the third plan, the scheduled route is B, the passage hand-over point is hand-over point 2, the travel distance is 1.5, the travel time is 45, the delivery share is three in B region and three in total, the time is 30, and the number of sections in charge is one. A transport share is such that three in B region and three in total, the empty seat count is two, the hand-over count is zero, the number of hand-over pieces is zero, the hand-over time is zero, the take-over count is one, the number of take-over pieces is three, and the take-over time is three, so the transport share holds. The operation start point is hand-over point 2, the operation start time is 108, and the last delivery completion time is 183.

For the vehicle number 3 of the third plan, the scheduled route is D→C, the passage hand-over point is hand-over points 1 and 2, the travel distance is 2.5, the travel time is 75, the delivery share is three in C region and three in total, the time is 30, and the number of sections in charge is one. A transport share is such that three in B region, three in C region, and six in total, the empty seat count is one, the hand-over count is one, the number of hand-over pieces is three, the hand-over time is three, the take-over count is zero, the number of take-over pieces is zero, and the take-over time is zero, so the transport share holds. The operation start point is D, the operation start time is 0, and the last delivery completion time is 108.

For the vehicle number 4 of the third plan, the scheduled route is D, the passage hand-over point is hand-over point 1, the travel distance is 1, the travel time is 30, the delivery share is five in D region and five in total, the time is 50, and the number of sections in charge is one. A transport share is such that five in D region and five in total, the empty seat count is one, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 80.

For the vehicle number 5 of the third plan, the scheduled route is D→E, the passage hand-over point is hand-over point 1, the travel distance is 3.5, the travel time is 105, the delivery share is two in E region and two in total, the time is 20, and the number of sections in charge is one. A transport share is such that four in A region, two in E region, and six in total, the empty seat count is one, the hand-over count is one, the number of hand-over pieces is four, the hand-over time is four, the take-over count is zero, the number of take-over pieces is zero, and the take-over time is zero, so the transport share holds. The operation start point is D, the operation start time is 0, and the last delivery completion time is 129.

As shown in FIG. 13D, in the third plan, five vehicles are needed in total, the travel distance is 12 in total, the travel time is 360 in total, the delivery share is four in total in A, three in total in B, three in total in C, five in total in D, and two in total in E, and the total delivery share is 17, the total time is 170, the total number of sections in charge is five, and the delivery efficiency is 1.42. A transport share is eight in total in A, six in total in B, three in total in C, five in total in D, and two in total in E, and the total number of transport share is 24. In a transport share, the empty seat count is seven in total, the hand-over count is two in total, the number of hand-over pieces is seven in total, the hand-over time is 7 in total, the take-over count is two in total, the number of take-over pieces is seven in total, and the take-over time is seven in total, so the transport share holds, and the last delivery completion time is up to 183.

For the vehicle number 1 of the fourth plan, the scheduled route is D→E, the passage hand-over point is hand-over point 1, the travel distance is 3.5, the travel time is 105, the delivery share is five in D region, two in E region and seven in total, the time is 70, and the number of sections in charge is two. A transport share is such that five in D region, two in E region, and seven in total, the empty seat count is zero, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 175.

For the vehicle number 2 of the fourth plan, the scheduled route is D→C A, the passage hand-over point is hand-over points 1 and 2, the travel distance is 4.5, the travel time is 135, the delivery share is four in A region and four in total, the time is 40, and the number of sections in charge is one. A transport share is such that four in A region and four in total, the empty seat count is two, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 175.

For the vehicle number 3 of the fourth plan, the scheduled route is D→C→B, the passage hand-over point is hand-over points 1 and 2, the travel distance is 4, the travel time is 120, the delivery share is three in B region, three in C region, and six in total, the time is 60, and the number of sections in charge is two. A transport share is such that three in B region, three in C region, and six in total, the empty seat count is one, the hand-over count is zero, the number of hand-over pieces is zero, the hand-over time is zero, the take-over count is zero, the number of take-over pieces is zero, and the take-over time is zero, so the transport share holds. The operation start point is D, the operation start time is 0, and the last delivery completion time is 180.

As shown in FIG. 13E, in the fourth plan, three vehicles are needed in total, the travel distance is 12 in total, the travel time is 360 in total, the delivery share is four in total in A, three in total in B, three in total in C, five in total in D, and two in total in E, and the total delivery share is 17, the total time is 170, the total number of sections in charge is five, and the delivery efficiency is 1.42. A transport share is four in total in A, three in total in B, three in total in C, five in total in D, and two in total in E, and the total number of transport share is 17. In a transport share, the empty seat count is 11 in total, the hand-over count is zero in total, the number of hand-over pieces is zero in total, the hand-over time is zero in total, the take-over count is zero in total, the number of take-over pieces is zero in total, the take-over time is zero in total, so the transport share holds, and the last delivery completion time is up to 180.

By using the thus calculated information for determining a dispatch candidate, the vehicle allocation schedule determination unit 36 determines a vehicle allocation candidate based on the predetermined condition from among the plurality of vehicle allocation candidates, that is, the reference schedule plan and first to fourth plans. With this configuration, it is possible to create a vehicle allocation schedule suitable for the predetermined condition. For example, the vehicle allocation schedule determination unit 36 determines a vehicle allocation candidate for a vehicle allocation schedule based on at least one of the delivery efficiency as a transport efficiency and the delivery completion time as transport completion time, as the predetermined condition. For example, the vehicle allocation schedule determination unit 36 determines a vehicle allocation candidate having the highest delivery efficiency and, when there is a plurality of vehicle allocation candidates having the same delivery efficiency, determines a vehicle allocation candidate having the earliest delivery completion time. Alternatively, the vehicle allocation schedule determination unit 36 may create a vehicle allocation schedule by determining a vehicle allocation candidate having the earliest delivery completion time and, when there is a plurality of vehicle allocation candidates having the same delivery completion time, determining a vehicle allocation candidate having the highest delivery efficiency. A condition other than the transport efficiency or the transport completion time may be applied as the predetermined condition. A vehicle allocation schedule may be created by determining a vehicle allocation candidate further in consideration of a condition related to, for example, a time period to be transported or the like.

As an example of a method of selecting a vehicle allocation schedule from among a plurality of vehicle allocation candidates as in the case of the reference schedule plan and the first to fourth plans, a plan having a higher delivery efficiency than the reference schedule plan is selected. When there is no plan having a higher delivery efficiency than the reference schedule plan, the reference schedule plan is selected.

When there is a boarding booking to transport people, a plan that applies to a booking condition is selected, and, when there is a plurality of plans that apply to the booking condition, a plan having the earliest completion time is selected.

When there is no plan that applies to a booking condition for the boarding booking, the fourth plan is selected, and available vehicles are allocated for flow of people.

Next, a specific process to be executed in the units of the information processing system 10 at the time when the payment service provided by the payment service server 11 is used for a service, such as the above-described vehicle allocation service provided by the vehicle allocation scheduling server 12, will be described.

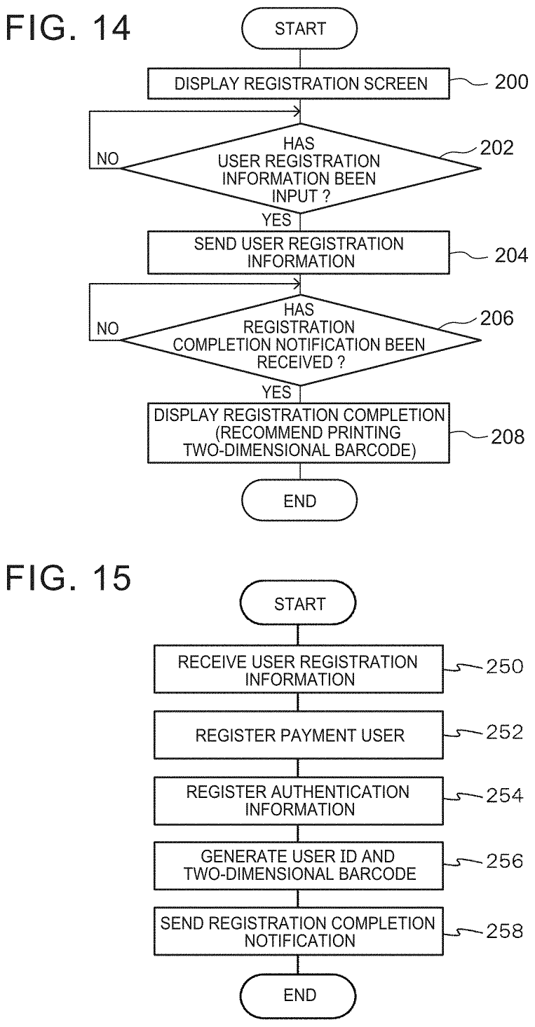

FIG. 14 is a flowchart showing an example of a process to be executed by the client terminal 18 for user registration in order to use the service provided by the payment service server 11 of the information processing system 10 according to the present embodiment. The process of FIG. 14 starts, for example, when the user of the client terminal 18 or the agent of the user operates the client terminal 18 and operates to provide instructions for user registration to the service provided by the payment service server 11.

In step 200, the CPU 18A displays a predetermined registration screen on the display unit 18F and then advances to step 202. A registration screen for inputting, for example, user registration information, such as the mail address of an e-mail, address, name, age, sex, and face photograph, is displayed.

In step 202, the CPU 18A determines whether the user registration information has been input via the operating unit 18E. The determination is to determine whether registration information for the user or the agent of the user to log in to the service provided by the payment service server 11 has been input. The CPU 18A determines whether, for example, user registration information, such as the mail address of an e-mail, address, name, age, sex, and face photograph, has been input, waits until affirmative determination is made, and then advances to step 204.

In step 204, the CPU 18A sends the user registration information to the payment service server 11 and then advances to step 206.

In step 206, the CPU 18A determines whether a registration completion notification has been received from the payment service server 11. The CPU 18A waits until affirmative determination is made and then advances to step 208.

In step 208, the CPU 18A displays registration completion on the display unit 18F and then advances to step 210. At the time of displaying registration completion, an authentication code, such as a two-dimensional barcode and a barcode, for authenticating the user may also be displayed to recommend the user to carry the printed authentication code at the time of going out. With this configuration, by carrying print having the authentication code printed thereon, the user is enabled to use the payment service provided by the payment service server 11 by using a client terminal of another person. In the present embodiment, it is possible to identify the user by taking a photograph of the print having a two-dimensional barcode as an example of the authentication code, printed thereon (hereinafter, which may also be simply referred to as two-dimensional barcode) or the face of the user.

FIG. 15 is a flowchart showing an example of a process to be executed for user registration on the payment service server 11 when the process is executed by the client terminal 18 for user registration in the information processing system 10 according to the present embodiment. The process of FIG. 15 starts, for example, when user registration information is sent from the client terminal 18.

In step 250, the CPU 11A receives user registration information sent from the client terminal 18 and then advances to step 252. In other words, when the CPU 11A receives user registration information sent in step 204, the registration unit 40 receives the user registration information.

In step 252, the CPU 11A performs payment user registration and then advances to step 254. In other words, the payment function unit 42 stores the user registration information received from the client terminal 18 in the user DB 44 as the payment user information.

In step 254, the CPU 11A performs authentication information registration and then advances to step 256. In other words, when the payment function unit 42 makes a request to the authentication function unit 46 to register the authentication information, the authentication function unit 46 stores the authentication information in the authentication information DB 48.

In step 256, the CPU 11A generates a user ID and a two-dimensional barcode corresponding the user ID and then advances to step 258.

In step 258, the CPU 11A sends a registration completion notification to the client terminal 18 and then ends the series of processes. As a result, affirmative determination is made in step 206. In step 256, at the time of sending a registration completion notification, the registration completion notification may be sent with a two-dimensional barcode. With this configuration, at the time of displaying registration completion on the client terminal 18, the client terminal 18 is able to prompt to carry print having a two-dimensional barcode thereon at the time of going out by displaying information prompting to print a two-dimensional barcode. In this case, step 256 may be regarded as a preprocessing unit.

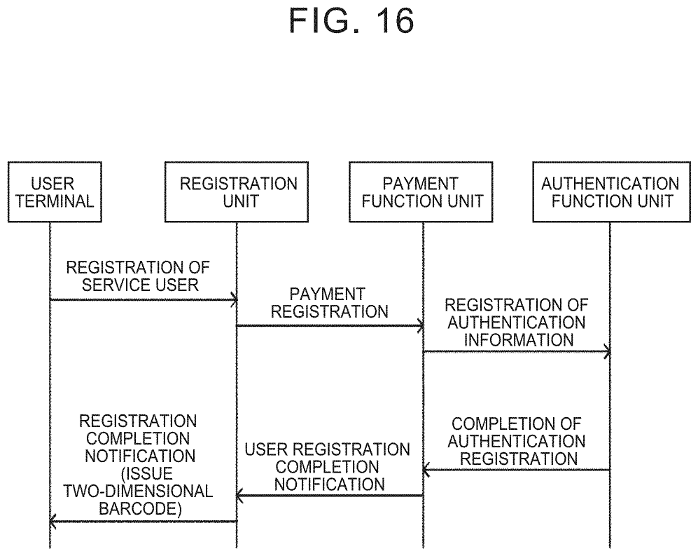

When the processes of the client terminal 18 and payment service server 11 are executed as described above, the units operate as shown in the sequence diagram of FIG. 16. FIG. 16 is a sequence diagram showing a process for user registration when the service provided by the payment service server 11 of the information processing system 10 according to the present embodiment is used.

In other words, for user registration, a user inputs user registration information to the registration screen displayed in step 200 by operating the client terminal 18 (the user terminal in FIG. 16) and sends the user registration information to the payment service server 11 for user registration.

In the payment service server 11, the registration unit 40 receives the user registration information and performs payment registration to the payment function unit 42.

The payment function unit 42 performs payment registration by storing the user registration information received from the client terminal 18 in the user DB 44 as payment user information.

The payment function unit 42 performs authentication information registration to the authentication function unit 46. The authentication function unit 46 performs authentication information registration by storing authentication information in the authentication information DB 48.

The payment function unit 42 waits for authentication registration completion of the authentication function unit 46 and then provides a user registration completion notification to the registration unit 40. With this configuration, the registration unit 40 generates a two-dimensional barcode for authentication and returns the user registration completion notification to the user terminal, with the result that registration of the user completes. With this configuration, in the present embodiment, since user information can be input and authenticated by taking a photograph of the face of the user or a photograph of the two-dimensional barcode for authentication, it is possible to easily perform input operation for authentication as compared to text input.

In this way, once user registration is performed to the payment service server 11, it is possible to execute a process of making a vehicle booking to the vehicle allocation scheduling server 12 and making a payment in the present embodiment. When a user, such as an elderly person, has no mobile terminal 18b for payment, the user is able to execute a process of making a vehicle booking and payment by using the client terminal 18, such as a mobile terminal 18b recognizing another user. Specific processes to be executed in the units of the information processing system 10 to make a vehicle booking and make a payment will be described as an example.

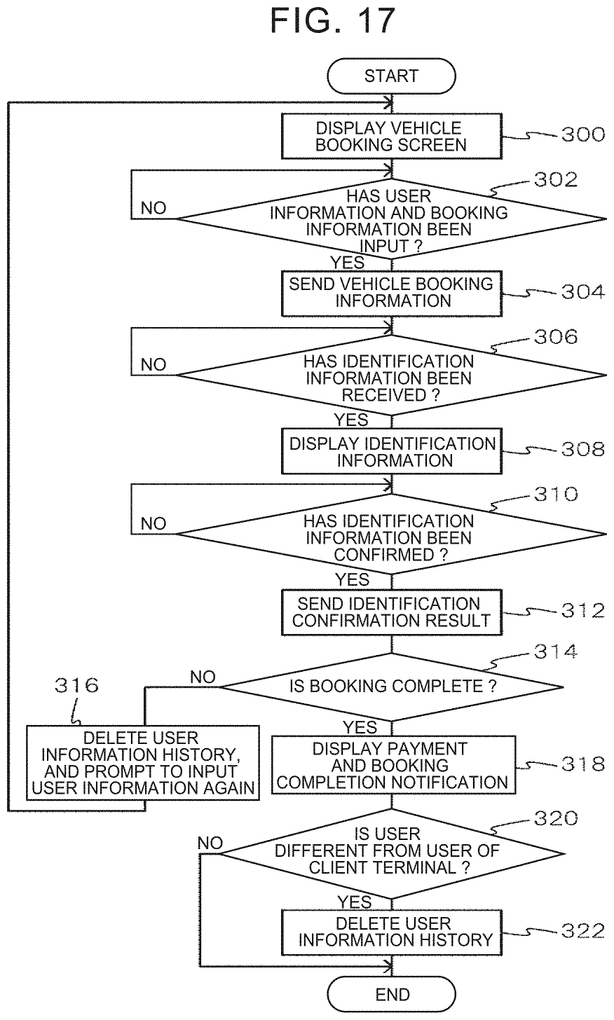

First, a process to be executed by the client terminal 18 to make a vehicle booking and make a payment will be described. FIG. 17 is a flowchart showing an example of a process to be executed by the client terminal 18 to make a vehicle booking and make a payment in the information processing system 10 according to the present embodiment. The process of FIG. 17 starts, for example, when a user provides instructions for using the service provided by the vehicle allocation scheduling server 12 by operating an application preinstalled in the client terminal 18, such as the mobile terminal 18b of the user or an agent.

In step 300, the CPU 18A displays a predetermined vehicle booking screen and then advances to step 302. For example, in the present embodiment, the CPU 18A displays a vehicle booking screen containing a photographing frame for taking a photograph of user's face or two-dimensional barcode as user information and fields for inputting booking information as vehicle allocation request information such as a point of departure, a destination, and date and time needed to make a vehicle booking. The current position information of the client terminal 18 may be applied as the point of departure contained in the booking information.

In step 302, the CPU 18A determines whether user information and booking information have been input. The determination is to determine whether, for example, a photograph of the face of the user or two-dimensional barcode as user information has been taken with a camera 18I of the client terminal 18 and booking information have been input. The CPU 18A waits until affirmative determination is made and then advances to step 304.

In step 304, the CPU 18A sends vehicle booking information to the vehicle allocation scheduling server 12 and then advances to step 306. In other words, the CPU 18A makes a vehicle booking by sending the user information and the booking information to the vehicle allocation scheduling server 12 as vehicle booking information.

In step 306, the CPU 18A determines whether identification information has been received from the vehicle allocation scheduling server 12. In the present embodiment, the user may be different from the user of the client terminal 18, so the determination is to determine whether identification information (for example, name, age, face photograph, or the like) for identifying the user has been received. The CPU 18A waits until affirmative determination is made and then advances to step 308.

In step 308, the CPU 18A displays the identification information on the display unit 18F and then advances to step 310. With this configuration, it is possible to check the user by using the displayed identification information, so it is possible to reliably check the user when the user is different from the user of the client terminal 18.

In step 310, the CPU 18A determines whether confirmation of identification has been input. The determination is to determine whether, for example, an identification result has been input by operating the operating unit 18E. The CPU 18A waits until affirmative determination is made and then advances to step 312.

In step 312, the CPU 18A sends the identification result to the vehicle allocation scheduling server 12 and then advances to step 314.

In step 314, the CPU 18A determines whether booking is complete. In the present embodiment, the determination is to determine whether a payment and booking completion notification has been received from the vehicle allocation scheduling server 12. When a payment and booking completion notification is not provided and a service unavailable notification is provided and negative determination is made, the CPU 18A advances to step 316; whereas, when affirmative determination is made, the CPU 18A advances to step 318.

In step 316, the CPU 18A deletes the history of user information (for example, historical information such as authentication information and log information) and prompts to input user information again and then returns to step 300 and repeats the above-described process.

In step 318, the CPU 18A displays the payment and booking completion notification on the display unit 18F and then advances to step 320.

In step 320, the CPU 18A determines whether the user is different from the user of the client terminal 18. When affirmative determination is made, the CPU 18A advances to step 322; whereas, when negative determination is made, the CPU 18A ends the series of processes.

In step 322, the CPU 18A deletes the history of user information and then ends the series of processes. As a result, information about the user different from the user of the client terminal 18 is deleted from the client terminal 18, and private information is protected.

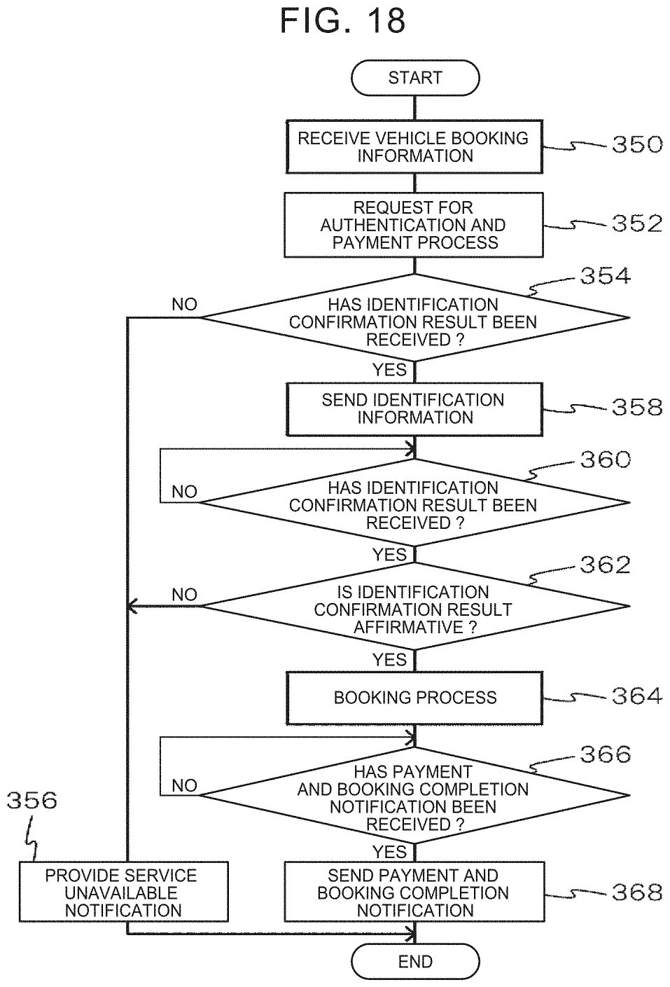

Next, a process to be executed by the vehicle allocation scheduling server 12 to make a vehicle booking and make a payment will be described. FIG. 18 is a flowchart showing an example of a process to be executed by the vehicle allocation scheduling server 12 to make a vehicle booking and make a payment in the information processing system 10 according to the present embodiment. The process of FIG. 18 starts, for example, when vehicle booking information is sent from the client terminal 18 in step 304.

In step 350, the CPU 12A receives the vehicle booking information and then advances to step 352. In other words, when the vehicle allocation reception unit 30 receives the vehicle booking information sent from the client terminal 18 in step 304, the vehicle allocation reception unit 30 receives the vehicle booking information as dispatch request information.

In step 352, the CPU 12A sends an authentication and payment process request to the payment service server 11 and then advances to step 354. In other words, the CPU 12A makes a request for authentication and payment process by sending the user information to the payment service server 11.

In step 354, the CPU 12A determines whether an identification result has been received from the payment service server 11. The determination is to determine whether a notification of identification information (for example, name, age, face photograph, or the like) for identifying the user as the identification result has been received from the payment service server 11. When the user is not authenticated as a registered user, negative determination is made, and the CPU 12A advances to step 356; whereas, when affirmative determination is made, the CPU 12A advances to step 358.

In step 356, the CPU 12A provides a service unavailable notification to the client terminal 18 and then ends the series of processes.

In step 358, the CPU 12A sends the identification information to the client terminal 18 and then advances to step 360. As a result, in step 308, the identification information is displayed on the display unit 18F of the client terminal 18.

In step 360, the CPU 12A determines whether the confirmation result of the identification information has been received from the client terminal 18, waits until affirmative determination is made, and then advances to step 362.

In step 362, the CPU 12A determines whether the identification result indicates that the identification information has been confirmed by the user. When negative determination is made, the CPU 12A advances to step 356; whereas, when affirmative determination is made, the CPU 12A advances to step 364.

In step 364, the CPU 12A executes a booking process for booking vehicle allocation and then advances to step 366. In the booking process, the vehicle allocation reception unit 30 receives vehicle booking information as vehicle allocation request information, creates the above-described vehicle allocation schedule, and provides the identification result to the payment service server 11 and makes a request to the payment service server 11 to make a payment for the authenticated user.

In step 366, the CPU 12A determines whether the payment and booking completion notification has been received from the payment service server 11. The CPU 12A waits until affirmative determination is made and then advances to step 368.

In step 368, the CPU 12A sends the payment and booking completion notification to the client terminal 18 and ends the series of processes.

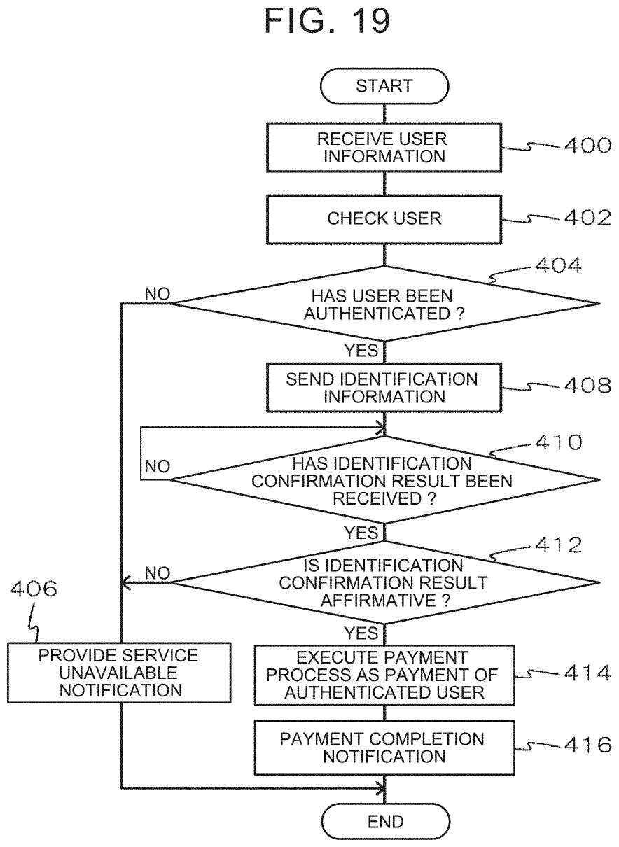

Next, a process to be executed by the payment service server 11 to make a vehicle booking and make a payment will be described. FIG. 19 is a flowchart showing an example of a process to be executed by the payment service server 11 to make a vehicle booking and make a payment in the information processing system 10 according to the present embodiment. The process of FIG. 19 starts, for example, when the vehicle allocation scheduling server 12 makes an authentication and payment process request in step 352.

In step 400, the CPU 11A receives user information from the vehicle allocation scheduling server 12 and then advances to step 402. In other words, when the CPU 11A receives the user information sent through the authentication and payment process request from the vehicle allocation scheduling server 12 in step 352.

In step 402, the CPU 11A checks the user based on the user information and then advances to step 404. In other words, the authentication and payment processing unit 50 inquires of the authentication function unit 46 about whether the user is registered, and the authentication function unit 46 checks whether the user is registered. Specifically, the authentication function unit 46 searches for the user corresponding to a face photograph or two-dimensional barcode as the user information.

In step 404, the CPU 11A determines whether the user has been authenticated. The determination is for the authentication and payment processing unit 50 to determine whether the user is a registered user upon receiving an identification result indicating a search result for the user from the authentication function unit 46. When negative determination is made, the CPU 11A advances to step 406; whereas, when affirmative determination is made, the CPU 11A advances to step 408.

In step 406, the CPU 11A sends a service unavailable notification to the vehicle allocation scheduling server 12 and then ends the series of processes.

In step 408, the CPU 11A sends the identification information to the vehicle allocation scheduling server 12 and then advances to step 410.

In step 410, the CPU 11A determines whether an identification result has been received. The determination is to determine whether an identification result has been received from the client terminal 18. The CPU 11A waits until affirmative determination is made and then advances to step 412. The identification result may be received via the vehicle allocation scheduling server 12. In the present embodiment, the client terminal 18 receives information indicating the identification of the user as an identification result. Alternatively, the client terminal 18 may prompt a user to input individual attributes (for example, pre-registered information, such as date of birth and telephone number) and receive the individual attributes as an identification result for two-factor authentication.

In step 412, the CPU 11A determines whether the identification result indicates that the identification information has been confirmed by the user. When negative determination is made, the CPU 11A advances to step 406; whereas, when affirmative determination is made, the CPU 11A advances to step 414.

In step 414, the CPU 11A executes a payment process as a payment of the authenticated user and then advances to step 416. In other words, the payment function unit 42 executes a process of making a payment for vehicle allocation as a payment of the authenticated user. With this configuration, a person who has no client terminal 18, such as the mobile terminal 18b capable of providing a payment service, is enabled to use a payment service provided by the payment service server 11. When the payment function unit 42 executes a payment process, the payment function unit 42 may acquire the position information of the client terminal 18 used by the user as a history of payment via the vehicle allocation scheduling server 12. With this configuration, it is possible to use the position information of the client terminal 18 as information to track fraud. When, for the payment process, the authenticated user is different from the user who owns the client terminal 18 in step 414, predetermined points or the like are returned to the user who owns the client terminal 18 as a value resulting from lending the client terminal 18 and allowing the authenticated user to make a payment. Returned points or the like may be informed to the client terminal 18.

In step 416, the CPU 11A provides a payment completion notification to the vehicle allocation scheduling server 12 and then ends the series of processes.

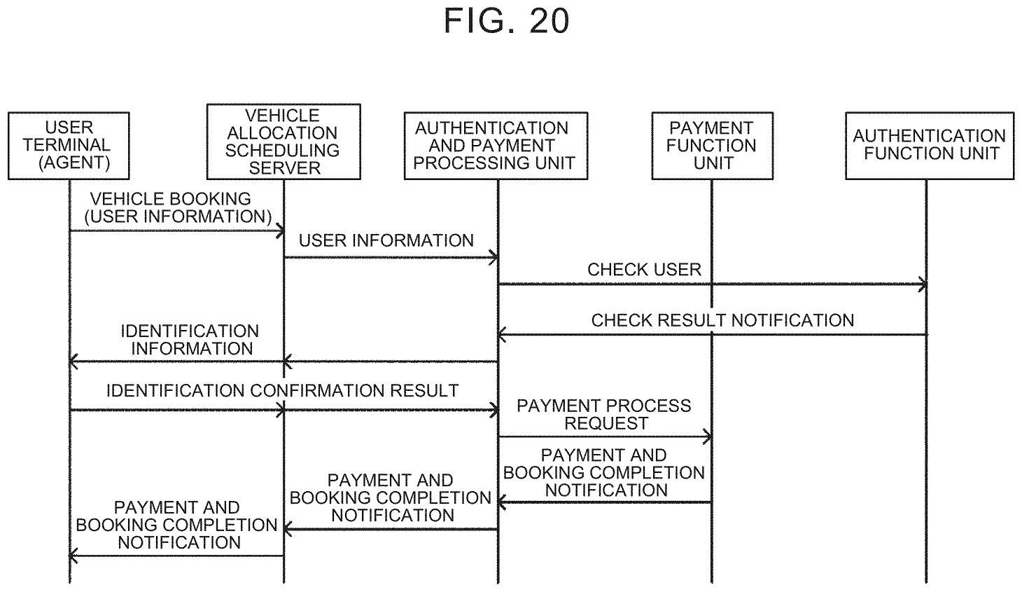

When the processes of the client terminal 18, the vehicle allocation scheduling server 12, and the payment service server 11 are executed as described above, the units operate as shown in the sequence diagram of FIG. 20. FIG. 20 is a sequence diagram showing a process to be executed to make a vehicle booking and make a payment in the information processing system 10 according to the present embodiment. FIG. 20 shows the case where, when a user has no client terminal 18, the user uses a user terminal of an agent.

Vehicle booking is made by sending booking information from the user terminal (agent) serving as the client terminal 18 and user information (a face photograph or photographed information obtained by taking a photograph of a two-dimensional barcode) to the vehicle allocation scheduling server 12.

The vehicle allocation scheduling server 12 makes an authentication and payment process request by sending the user information received from the user terminal to the authentication and payment processing unit 50 of the payment service server 11.

Upon receiving the authentication and payment process request, the authentication and payment processing unit 50 makes inquiry of the authentication function unit 46 to check for the user. The authentication function unit 46 performs authentication by checking whether the user is registered and returns an authentication result notification to the authentication and payment processing unit 50.

The authentication and payment processing unit 50 sends identification information for identifying the user to the user terminal via the vehicle allocation scheduling server 12 and prompts the user to confirm the identification information.

When the authentication and payment processing unit 50 receives from the user terminal the identification result indicating that the user has confirmed the identification information, the authentication and payment processing unit 50 provides a payment and booking completion notification to the user terminal via the vehicle allocation scheduling server 12 and then ends the process including vehicle booking to payment. By executing the process in this way, a person who has no mobile terminal 18b or the like, capable of providing a payment service, is enabled to use a payment service.

Subsequently, specific processes to be executed in the units of the information processing system 10 at the time of getting on or off the thus booked vehicle will be described.

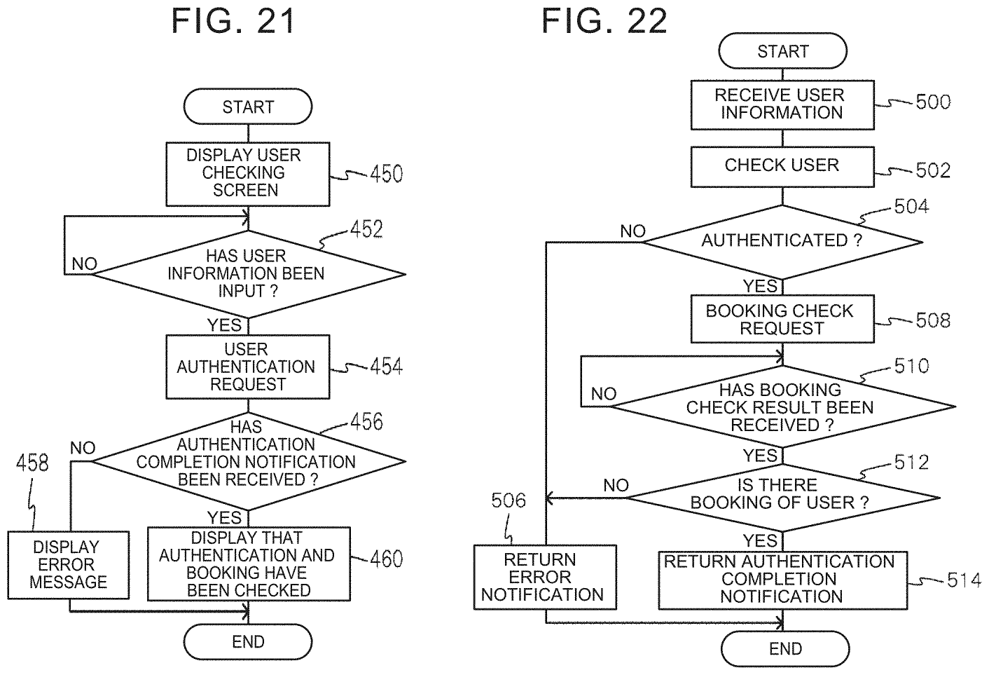

First, a process to be executed in the vehicle-side terminal 20 at the time of getting on or off the booked vehicle will be described. FIG. 21 is a flowchart showing an example of a process to be executed by the vehicle-side terminal 20 at the time of getting on or off a booked vehicle in the information processing system 10 according to the present embodiment. The process of FIG. 21 starts, for example, when a driver of a taxi 26 or bus 28 operates the vehicle-side terminal 20 to issue instructions for user checking.

In step 450, the CPU 20A displays a predetermined user checking screen on the display unit 20F and then advances to step 452.

In step 452, the CPU 20A determines whether user information has been input. The determination is to determine whether, for example, the vehicle-side terminal 20 has been operated to take a photograph of the face of the user or a photograph of a two-dimensional barcode with the camera 20I and the face photograph or the photo image of the two-dimensional barcode has been acquired as user information. The CPU 20A waits until affirmative determination is made and then advances to step 454.

In step 454, the CPU 20A makes a user authentication request to the payment service server 11 and then advances to step 456. In other words, the CPU 20A sends the user information to the payment service server 11 to make a request to authenticate the user corresponding to the user information and check the booking of the user.

In step 456, the CPU 20A determines whether an authentication completion notification has been received from the payment service server 11. Negative determination is made when the user is not a registered user and an error notification has been received from the payment service server 11, and the CPU 20A advances to step 458; whereas, when the user is authenticated as a registered user and an authentication completion notification has been received, affirmative determination is made, and the CPU 20A advances to step 460.

In step 458, the CPU 20A displays an error message on the display unit 20F and then ends the series of processes.

In step 460, the CPU 20A displays on the display unit 20F that authentication and booking have been checked and then ends the series of processes. As a result, the fact that authentication and booking of the user have been checked is informed to the driver.

Next, a process to be executed by the payment service server 11 at the time of getting on or off a booked vehicle will be described. FIG. 22 is a flowchart showing an example of a process to be executed by the payment service server 11 at the time of getting on or off a booked vehicle in the information processing system 10 according to the present embodiment. The process of FIG. 22 starts, for example, when the vehicle-side terminal 20 makes a user authentication request.

In step 500, the CPU 11A receives the user information from the vehicle-side terminal 20 and then advances to step 502. In other words, the authentication and payment processing unit 50 receives the authentication request containing the user information.

In step 502, the CPU 11A checks the user based on the user information and then advances to step 504. In other words, the authentication function unit 46 authenticates the user by searching the authentication information DB 48 for the user corresponding to the user information.

In step 504, the CPU 11A determines whether the user has been authenticated. The determination is for the authentication and payment processing unit 50 to determine whether the user has been authenticated based on an authentication result of the authentication function unit 46, that is, whether the user is a registered user. When negative determination is made, the CPU 11A advances to step 506; whereas, when affirmative determination is made, the CPU 11A advances to step 508.

In step 506, the CPU 11A returns an error notification to the vehicle-side terminal 20 and ends the series of processes. As a result, in the vehicle-side terminal 20, the determination of step 456 is negative.

In step 508, the CPU 11A makes a booking check request to the vehicle allocation scheduling server 12 and then advances to step 510. For sending a booking check request, the CPU 11A provides the vehicle allocation scheduling server 12 with user information, such as user ID, that can identify the user.

In step 510, the CPU 11A determines whether a booking check result has been received from the vehicle allocation scheduling server 12. The CPU 11A waits until affirmative determination is made and then advances to step 512.

In step 512, the CPU 11A determines whether there is a user's booking based on the booking check result. When negative determination is made, the CPU 11A advances to step 506; whereas, when affirmative determination is made, the CPU 11A advances to step 514.

In step 514, the CPU 11A returns an authentication completion notification to the vehicle-side terminal 20 and then ends the series of processes. As a result, in the vehicle-side terminal 20, affirmative determination is made in step 456.

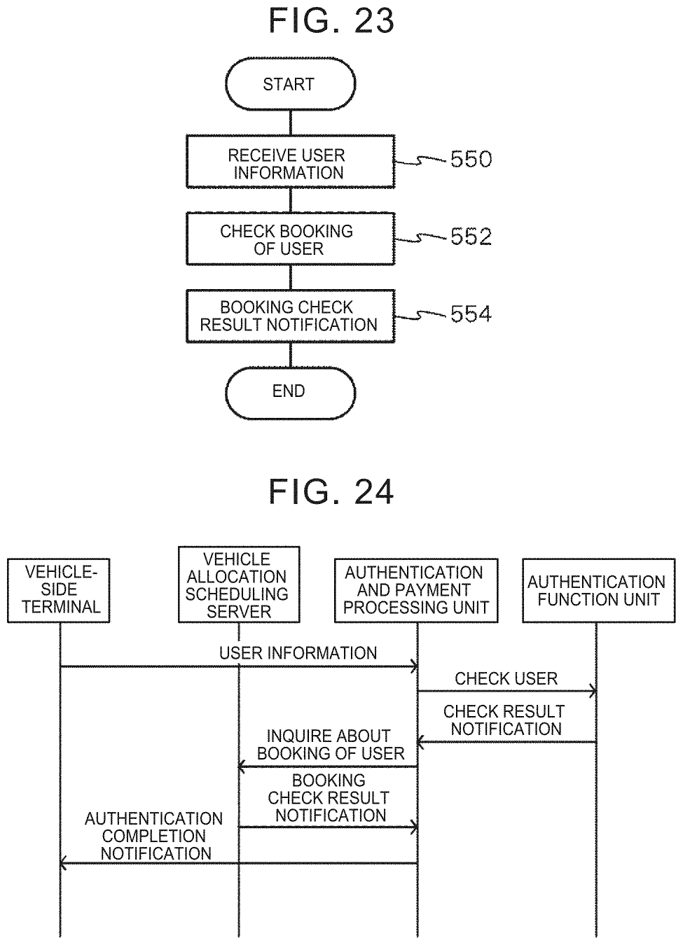

Next, a process to be executed in the vehicle allocation scheduling server 12 at the time of getting on or off the booked vehicle will be described. FIG. 23 is a flowchart showing an example of a process to be executed by the vehicle allocation scheduling server 12 at the time of getting on or off a booked vehicle in the information processing system 10 according to the present embodiment. The process of FIG. 23 starts, for example, when a booking check request has been made from the payment service server 11.

In step 550, the CPU 12A receives user information from the payment service server 11 and then advances to step 552. In other words, the CPU 12A receives the user information transmitted through the booking check request in step 508.

In step 552, the CPU 12A checks the booking of the user authenticated by the payment service server 11 and then advances to step 554. For example, the CPU 12A checks whether the booking user ID matches the user ID authenticated by the payment service server 11.

In step 554, the CPU 12A provides the payment service server 11 with a booking check result and then ends the series of processes.

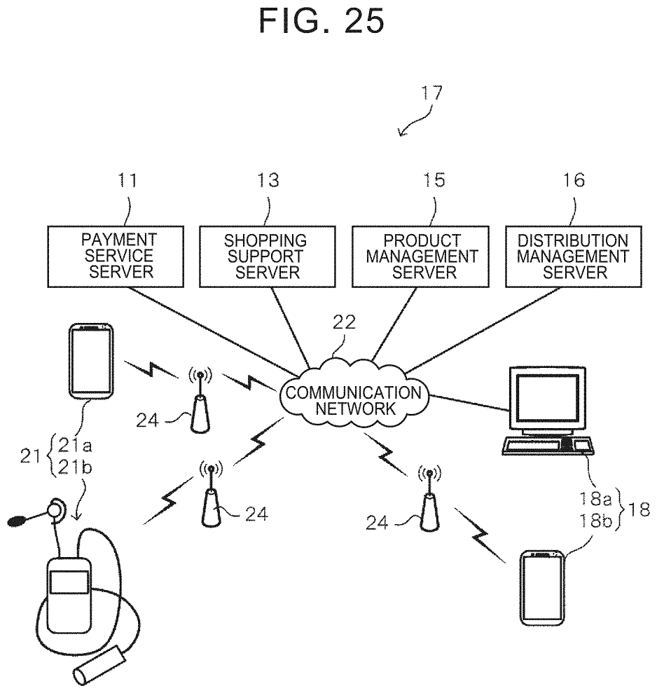

When the processes of the vehicle-side terminal 20, the payment service server 11, and the vehicle allocation scheduling server 12 are executed as described above, the units operate as shown in the sequence diagram of FIG. 24. FIG. 24 is a sequence diagram showing a process executed at the time of getting on or off a booked vehicle in the information processing system 10 according to the present embodiment.

When the driver operates the vehicle-side terminal 20 to take a photograph of the face of a passenger (user) or two-dimensional barcode with the camera 20I, the vehicle-side terminal 20 acquires the face photograph or the two-dimensional barcode as user information. Then, the vehicle-side terminal 20 makes a user authentication request to the authentication and payment processing unit 50 of the payment service server 11 by sending the user information to the authentication and payment processing unit 50.

The authentication and payment processing unit 50 checks the user by sending the user information to the authentication function unit 46.

The authentication function unit 46 performs authentication by searching the authentication information DB for the user corresponding to the user information, and provides a check result notification to the authentication and payment processing unit 50.

The authentication and payment processing unit 50 makes a request to the vehicle allocation scheduling server 12 to confirm the booking of the authenticated user and receives a booking confirmation result notification.

Then, when the authentication and payment processing unit 50 has confirmed the booking, the authentication and payment processing unit 50 provides an authentication completion result to the vehicle-side terminal 20. Thus, it is possible to identify the booking user.

When a vehicle allocation schedule made by the vehicle allocation scheduling server 12 for a vehicle booking contains transit, a user is able to make transit while performing identification by authenticating the user in each vehicle with the use of a two-dimensional barcode.

In the above-described embodiment, the payment service server 11, the vehicle allocation scheduling server 12, and the operation management server 14 are described as different servers; however, the configuration is not limited thereto. For example, the functions of the three servers may be provided in a single server, or the functions of any one or more of the servers may be distributed to a plurality of servers as needed and each of the any one or more of the servers may be made up of the plurality of servers. For example, the authentication function unit 46 of the payment service server 11 may be the function of an authentication-specific server.

In the above-described embodiment, taxis 26 and buses 28 are described as examples of the vehicles on which a vehicle allocation schedule is created; however, the vehicles are not limited thereto. For example, vehicles of pre-registered freight companies, pre-registered public vehicles, and the like may be used. Second Embodiment

In the first embodiment, a payment method with which a user uses the client terminal 18 of another user when the user uses a booked vehicle is described. A second embodiment is applied to the case where a user does some shopping by using the client terminal 18 of another user.

FIG. 25 is a diagram showing the schematic configuration of an information processing system 17 according to the second embodiment. Like reference signs denote similar components to those of the first embodiment, and the detailed description may not be repeated.

As shown in FIG. 25, the information processing system 17 according to the present embodiment includes a payment service server 11, a shopping support server 13 as a service providing apparatus, a product management server 15, a distribution management server 16, client terminals 18, and shopping service operator terminals 21. The servers and terminals are connected to the communication network 22.

As in the case of the first embodiment, even when a pre-registered user has no client terminal 18 equipped with a payment function, the payment service server 11 provides a service that enables the pre-registered user to make a payment by using a client terminal 18 of an agent.

The shopping support server 13 provides a service for supporting a user in shopping at a pre-registered shop. In the present embodiment, as one example, the shopping support server 13 provides a shopping agent service through real-time streaming, a service providing a shopping list generated including a past purchase history of a user, sales items, and the like, or other services, as shopping support.

The product management server 15 has the function of a database that stores product information and information, such as the purchase histories of users and, for shopping support, provides the stored information. The product management server 15 has the function of managing products by using a known technology, such as a point-of-sale (POS) system.

The distribution management server 16, for example, arranges delivery of purchased products by using a service provided by the shopping support server 13.

As in the case of the first embodiment, the client terminal 18 functions as an interface for accessing servers, such as cloud servers, that provide various services and receiving various services. In the present embodiment, the client terminal 18 functions as an interface for accessing the shopping support server 13 and receiving a service provided by the shopping support server 13. For example, as in the case of the first embodiment, the client terminal 18 may be a personal computer 18a or may be a mobile terminal 18b, such as a smartphone, or may be an internet TV or the like. When the mobile terminal 18b is applied, the mobile terminal 18b is connected to the communication network 22 via the wireless relay station 24 or the like.

The shopping service operator terminal 21 has a function of recording streaming video to be used for a shopping service provided by the shopping support server 13 and a function of speaking to a user. The shopping service operator terminal 21 is connected to the communication network 22 via the wireless relay station 24. For example, as shown in FIG. 25, the shopping service operator terminal 21 may be a mobile terminal 21a, such as a smartphone, or may be a wearable terminal 21b including a headset and a camera.

Various networks, such as a local area network (LAN), a wide area network (WAN), the Internet, and an intranet, may be used for the communication network 22. The communication network 22 sends or receives various data among connected devices.

Next, the configuration of the main part of the electrical system of each of the shopping support server 13, the product management server 15, the distribution management server 16, and the shopping service operator terminal 21 in the information processing system 10 according to the present embodiment will be described.

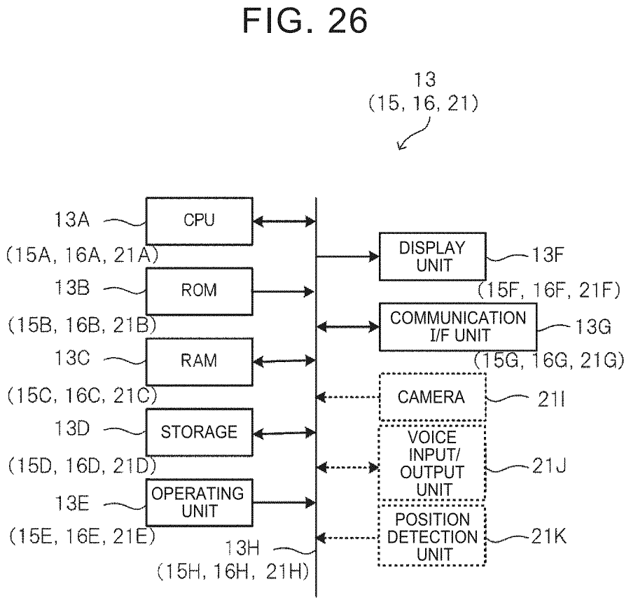

FIG. 26 is a block diagram showing the configuration of the main part of the electrical system of each of the shopping support server 13, the product management server 15, the distribution management server 16, and the shopping service operator terminal 21. The shopping support server 13, the product management server 15, the distribution management server 16, and the shopping service operator terminal 21 each are basically made up of a general computer, so the shopping support server 13 will be described as a representative here.

As shown in FIG. 26, the shopping support server 13, as well as the payment service server 11, includes a CPU 13A, a ROM 13B, a RAM 13C, a storage 13D, an operating unit 13E, a display unit 13F, and a communication I/F unit 13G.

The CPU 13A is a central processing unit and governs the operation of the whole apparatus by executing various programs. Various control programs, various parameters, and the like, are prestored in the ROM 13B. The RAM 13C is used as a work area or the like when the CPU 13A executes various programs. The storage 13D is made up of at least any one of various storage units, such as a hard disk drive (HDD), a solid state drive (SSD), and a flash memory. Various pieces of data, application programs, and the like are stored in the storage 13D. The operating unit 13E is made up of at least any one of a keyboard, a mouse, a touch panel, and the like and is used to input various pieces of information. The display unit 13F is used to display various pieces of information. The communication I/F unit 13G is capable of connecting with the communication network 22 such as a LAN, a WAN, and the Internet, and sending and receiving various data to and from another apparatus connected to the communication network 22. The units of the above-described shopping support server 13 are electrically connected to one another by a system bus 13H.

With the above configuration, the shopping support server 13 uses the CPU 13A to access the ROM 13B, the RAM 13C, and the storage 13D, to acquire various pieces of data via the operating unit 13E, and to display various pieces of information on the display unit 13F. The shopping support server 13 also uses the CPU 13A to control send and receive communication data via the communication I/F unit 13G.

As in the case of the client terminal 18 of the first embodiment, the shopping service operator terminal 21 further includes a camera 21I, a voice input/output unit 21J, a position detection unit 21K, and the like, as represented by the dashed lines in FIG. 26.

The camera 21I generates image data representing a moving image or a still image by taking a moving image or a still image. The shopping service operator terminal 21 of the present embodiment streams in real time video recorded by the camera 21I on the client terminal 18.

The voice input/output unit 21J outputs voice from a speaker, a headphone, or the like, and inputs voice by collecting sound with a microphone or the like and generates voice information representing the input voice. In the present embodiment, with the voice input/output unit 21J, a shopping service operator and a user are able to make conversation with each other.

The position detection unit 21K detects current position information of the shopping service operator terminal 21. For example, the position detection unit 21K receives radio waves from global positioning system (GPS) satellites and determines the position of one point in a space based on distances from the three or more GPS satellites.

Next, a service provided by the thus configured shopping support server 13 of the information processing system 17 according to the present embodiment will be described by way of a specific example.

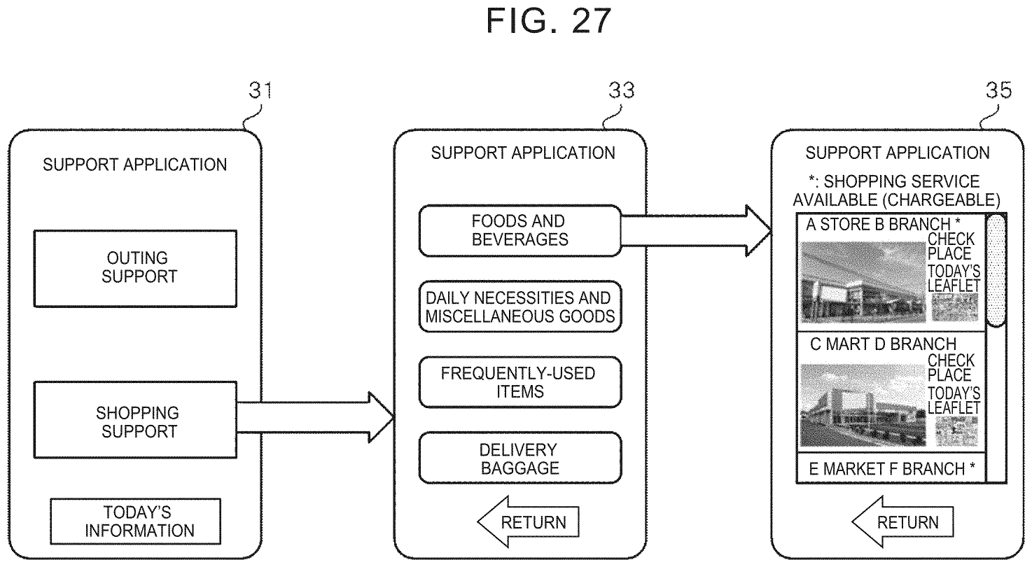

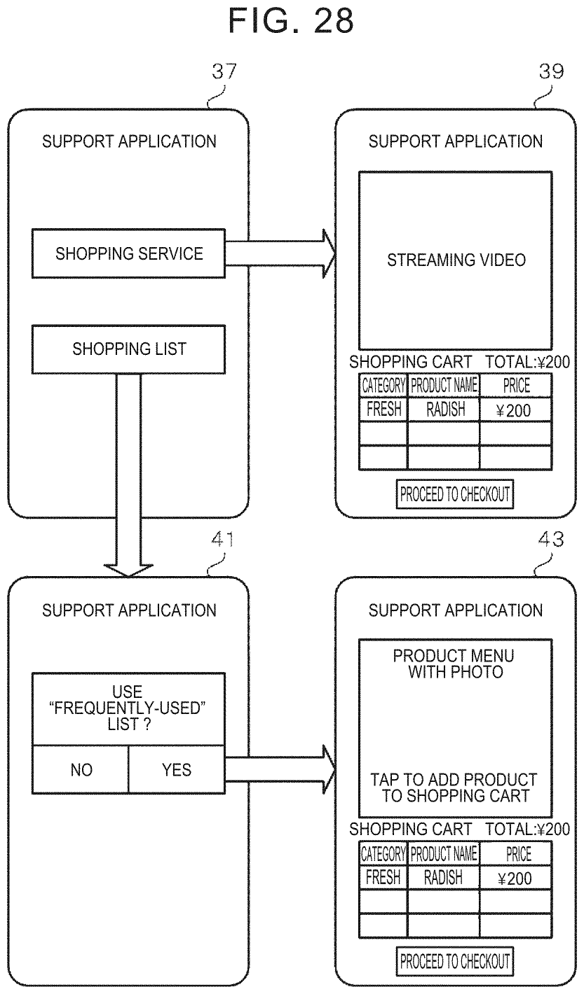

FIG. 27 is a view showing a default screen, a shopping item select screen, and a shop select screen as examples of screens to be displayed by a support application preinstalled in the client terminal 18. Hereinafter, examples of screens in the case where the client terminal 18 is a mobile terminal 18b, such as a smartphone, will be described, and, on the following examples of screens, buttons and the like on the screen displayed on the display unit 18F are operated by operating the operating unit 18E of the mobile terminal 18b.

When the support application is launched on the client terminal 18, the default screen 31 shown in FIG. 27 shows up. In the example of FIG. 27, the default screen 31 contains select buttons for selecting “OUTING SUPPORT”, “SHOPPING SUPPORT” “TODAY'S INFORMATION”, and the like.

When “SHOPPING SUPPORT” on the default screen 31 is selected, the shopping item select screen 33 shows up. In the example of FIG. 27, the shopping item select screen 33 shows select buttons for selecting “FOODS AND BEVERAGES”, “DAILY NECESSITIES AND MISCELLANEOUS GOODS”, “FREQUENTLY-USED ITEMS”, “DELIVERY BAGGAGE”, and the like. The shopping item select screen 33 contains “RETURN” button. When the “RETURN” button is selected, the screen returns to the default screen 31.

When “FOODS AND BEVERAGES” on the shopping item select screen 33 is selected, the shop select screen 35 shows up. In the example of FIG. 27, the shop select screen 35 contains select items for selecting “A STORE B BRANCH”, “C MART D BRANCH”, “E MARKET F BRANCH”, and the like. In the example of FIG. 27, each select item contains a link with “TODAY'S LEAFLET”. When “TODAY'S LEAFLET” is selected, advertisement information for the shop is displayed as recommended information. Shops to be displayed are pre-registered shops. A mark (“*” in FIG. 27) that indicates a shop available to shopping service is displayed. The shop select screen 35 contains “RETURN” button. When the “RETURN” button is selected, the screen returns to the shopping item select screen 33. Alternatively, the screen may return to the default screen 31.

Next, various screens to be displayed in the case where a shop available to shopping service is selected on the shop select screen 35 will be described. FIG. 28 is a view showing a shopping support select screen, a streaming screen, a shopping list on/off select screen, and a shopping list screen as examples of screens to be displayed for shopping at shops.

When a shop available to shopping service is selected on the shop select screen 35, the shopping support select screen 37 shows up. The shopping support select screen 37 contains select buttons for selecting “SHOPPING SERVICE” AND “SHOPPING LIST”. In this way, in the present embodiment, since the two select buttons for a way of shopping with “SHOPPING SERVICE” and a way of shopping with “SHOPPING LIST” are preferentially displayed, it is possible to reduce complication of a user due to showing information more than necessary. In the present embodiment, as an example of preferentially displaying two select buttons, an example of displaying only two select buttons will be described; however, the configuration is not limited thereto. Another select button may be displayed by scrolling. As an example of another select button, like general internet shopping, product items may be displayed in a predetermined order and an ordinary purchase button for selecting an object to be purchased, or the like, may be displayed.

The streaming screen 39 is a screen for shopping through streaming in real time video recorded by a shopping service operator with the shopping service operator terminal 21 while speaking to the shopping service operator. In the example of FIG. 28, the streaming screen 39 contains streaming video, a total amount in shopping cart, the categories, product names, and prices of products selected, “PROCEED TO CHECKOUT” button for checkout, and the like. On the streaming screen 39, for example, a user virtually does shopping by speaking to an operator to instruct the operator. When an intended product is determined, the shopping service operator registers the product into a shopping list by operating the shopping service operator terminal 21, with the result that the product is added to the shopping cart on the streaming screen 39 in FIG. 28. Addition of a product to the shopping cart may be performed by operating the operating unit 20E or may be performed by reading the barcode or the like of the product with the camera 20I or the like.

On the other hand, when “SHOPPING LIST” is selected on the shopping support select screen 37, the shopping list on/off select screen 41 shows up. The shopping list on/off select screen 41 is a screen for selecting whether to do shopping by using “FREQUENTLY-USED” list as a shopping list generated from a past purchase history of the user. As shown in FIG. 28, a message for determining yes or no (USE “FREQUENTLY-USED” LIST?) and buttons for selecting “YES” or “NO” show up.

When “YES” is selected on the shopping list on/off select screen 41, the shopping list screen 43 shows up. In the example of FIG. 28, the shopping list screen 43 contains product menu items with photos in a shopping list, a total amount in shopping cart, the categories, product names, and prices of products selected, “PROCEED TO CHECKOUT” button for checkout, and the like.

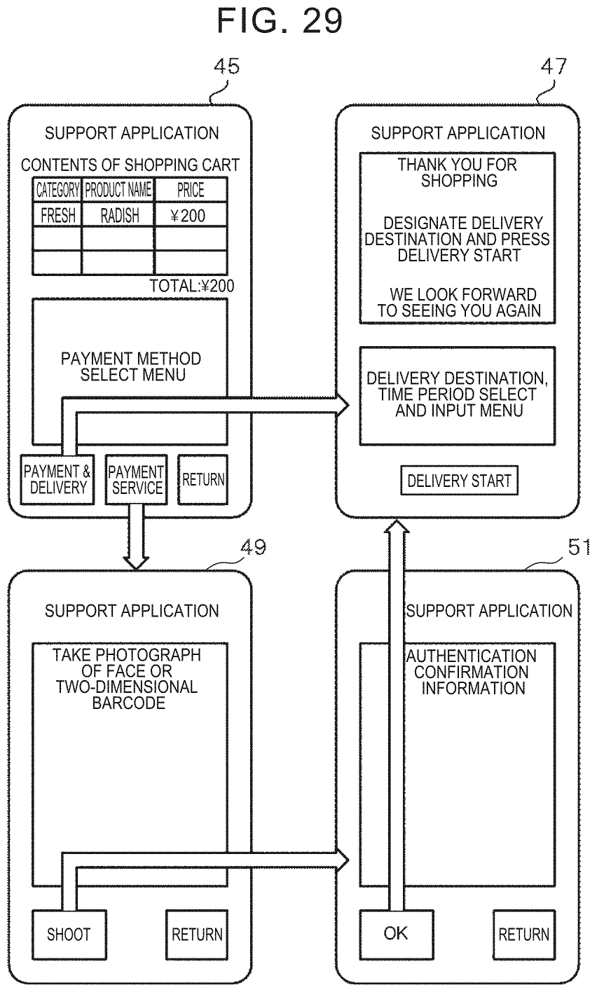

Next, various screens to be displayed in the case where “PROCEED TO CHECKOUT” is selected on the streaming screen 39 or the shopping list screen 43 will be described. FIG. 29 is a view showing a payment screen, a delivery screen, a payment service authentication screen, and an authentication confirmation screen as examples of screens to be displayed when “PROCEED TO CHECKOUT” is selected on the streaming screen 39 or the shopping list screen 43.

The payment screen 45 contains the categories, product names, and prices of products selected as items in the shopping cart, a total amount, and a menu for selecting a payment method. As a menu for selecting a payment method, various payment methods, such as credit card payment and bank transfer, are displayed as examples. The payment screen 45 also contains buttons for “PAYMENT & DELIVERY”, “PAYMENT SERVICE”, “RETURN”, and the like.

When “PAYMENT & DELIVERY” is selected on the payment screen 45, the delivery screen 47 shows up. The delivery screen 47 shows a message from a shop (in the example of FIG. 29, “THANK YOU FOR SHOPPING. DESIGNATE DELIVERY DESTINATION AND PRESS DELIVERY START. WE LOOK FORWARD TO SEEING YOU AGAIN.). The delivery screen 47 contains a menu for selecting or inputting a delivery destination, a time period, and the like and also contains “DELIVERY START” button. When a delivery destination and a time period are designated and then “DELIVERY START” is selected, shopping ends. Delivery of purchased products is arranged by the distribution management server 16.

In the present embodiment as well, a payment service provided by the payment service server 11 of the above-described embodiment is available, and, when, for example, “PAYMENT SERVICE” is selected on the payment screen 45, the payment service authentication screen 49 shows up. The payment service authentication screen 49 contains a photo image of the user or two-dimensional barcode taken by the camera 18I. When “SHOOT” is selected, the face photograph of the user or two-dimensional barcode displayed is acquired as user information.

When “SHOOT” is selected on the payment service authentication screen 49, the authentication confirmation screen 51 shows up. On the authentication confirmation screen 51, identification information (for example, name, age, face photograph, or the like) for identifying the user is displayed in the region for authentication confirmation information, shown in FIG. 29, based on the result authenticated by the payment service server 11, and the user is enabled to confirm the identification.

In the present embodiment, when a photograph of the face of the user or, a printed two-dimensional barcode, or the like is taken in a state where the payment service authentication screen 49 is displayed, the payment service provided by the payment service server 11 can be used through a similar process to the process of the payment service server 11, shown in FIG. 29. For example, a user who is difficult to operate the client terminal 18, such as the elderly person, is able to make a request of an agent or the like to use the client terminal 18 of the agent or the like and execute processes for shopping and payment. In other words, even when a shopping user has no client terminal 18, such as the mobile terminal 18b, the user is enabled to do shopping by using a client terminal 18 of another person, and the payment service server 11 is capable of making a payment for the shopping user by authenticating the user.

In the above-described second embodiment, when a shop is selected on the shop select screen 35, the shopping support select screen 37 shows up to prompt a user to select “SHOPPING SERVICE” or “SHOPPING LIST”. Alternatively, any one of “SHOPPING SERVICE” and “SHOPPING LIST” may be automatically selected in accordance with a predetermined condition. When, for example, a user browses a notification of products from a shop, the user is highly likely to be interested in a product other than a shopping list, and the user is highly likely to select a way of shopping through “SHOPPING SERVICE”. In this case, after a user browses a notification from a shop, such as “TODAY'S LEAFLET” shown in FIG. 27, sales advertisement, and a notice of recommended products, when a shop is selected, “SHOPPING SERVICE” may be automatically selected. Thus, it is possible to omit time and effort of a user to select

“SHOPPING SERVICE”.

In the second embodiment, the payment service server 11, the shopping support server 13, the product management server 15, and the distribution management server 16 are described as different servers; however, the configuration is not limited thereto. For example, the functions of the four servers may be provided in a single server, or the functions of any one or more of the servers may be distributed to a plurality of servers as needed and each of the any one or more of the servers may be made up of the plurality of servers. For example, the authentication function unit 46 of the payment service server 11 may be the function of an authentication-specific server.

In each of the above-described embodiments, at the time of using a payment service, face authentication is described as an example of biometric authentication. Alternatively, biometric authentication may use characteristic biometric information of a human body, such as finger print, retina, iris, and voice, other than face.

The information processing systems 10, 17 in the above-described embodiments may be combined as a single information processing system. A server other than the above-described servers may be further included to provide various cloud services.

In the first embodiment, an example in which a vehicle allocation service is applied as a predetermined service is described, and, in the second embodiment, an example in which a shopping service is applied as a predetermined service is described; however, services intended for a payment service are not limited to those services. For example, a payment service may be used for other various cloud services and the like.

The processes to be executed in the units of the information processing systems 10, 17 in the above-described embodiments are described as software processes executed by running programs; however, the configuration is not limited thereto. For example, the processes may be executed by hardware, such as a graphics processing unit (GPU), application specific integrated circuit (ASIC), and field-programmable gate array (FPGA). Alternatively, the processes may be executed by a combination of both software and hardware. When the processes are executed by software, programs may be stored in various storage media and distributed.

The present disclosure is not limited to the above-described embodiments and may be, of course, modified into various forms without departing from the scope of the present disclosure. For example, an unnecessary step may be deleted, a new step may be added, or the order of processing may be interchanged, without departing from the scope of the present disclosure.

What is claimed is:

1. A payment service apparatus comprising:
a reception unit configured to receive user information from a client terminal equipped with a payment function and used by a first user; and
a processing unit configured to, when a user authenticated based on the user information received by the reception unit is a second user different from the first user, perform a payment process for the second user.

2. The payment service apparatus according to claim 1, wherein the reception unit is configured to, when the reception unit receives the user information, further receive position information of the client terminal.

3. The payment service apparatus according to claim 1, wherein the client terminal is configured to, after the processing unit executes the payment process, delete historical information about the second user.

4. The payment service apparatus according to claim 1, wherein the processing unit is configured to, when the authenticated user is the second user, further return a predetermined bonus to the first user.

5. The payment service apparatus according to claim 1, wherein:
the client terminal includes a photographing unit; and
the reception unit is configured to receive a photograph of biometric information or predetermined authentication print of a user, taken by the photographing unit, as the user information.

6. The payment service apparatus according to claim 5, further comprising a preprocessing unit configured to, after the user is authenticated and registered, execute a process of generating an authentication code for printing out the authentication print and prompting to print out the generated authentication code.

7. A payment service system comprising:
the payment service apparatus according to claim 1;
a service providing apparatus configured to provide a predetermined service; and
a client terminal equipped with a payment function and used by the first user and used to input the user information of a user to which the service is provided.

8. The payment service system according to claim 7, wherein:
the service providing apparatus is configured to provide a vehicle allocation service on allocation of a vehicle;
the client terminal includes a photographing unit; and
the payment service apparatus is configured to, when allocation of a vehicle is arranged by using the vehicle allocation service, identify the second user by using a photo image of authentication print, taken by the photographing unit and held by the second user, the authentication print being printed in advance.

9. A payment service method that is executed by a computer, the payment service method comprising:
receiving user information from a client terminal equipped with a payment function and used by a first user;
executing a process of authenticating a user based on the received user information; and
when the authenticated user is a second user different from the first user, performing a payment process for the second user.

10. A payment service program for causing a computer to function as the units of the payment service apparatus according to claim 1.
